(19) United States
(12) Patent Application Publication
(10) Pub. No.: US 2009/0063612 A1
(43) Pub. Date: Mar. 5, 2009

(54) Image forming apparatus and image forming system

(76) Inventor: Kiyohiro Hyo, Kanagawa (JP)

Correspondence Address: HARNESS, DICKEY & PIERCE, P.L.C., P.O. BOX 8910, RESTON, VA, 20195, US

(21) Appl. No.: 12/230,294

(22) Filed: Aug. 27, 2008

(30) Foreign Application Priority Data
Aug. 30, 2007 (JP) 2007-224098
Nov. 7, 2007 (JP) 2007-290216

(51) Int. Cl. G06F 15/16

(52) U.S. Cl. 709/201

(57) ABSTRACT

When plural image forming apparatuses support different formats for a request, the content of the request is analyzed and processed properly in an image forming apparatus. The image forming apparatus comprises a communication unit configured to receive a request from a client apparatus in a predetermined description format; a request analysis unit configured to analyze the request to acquire and output a request item included in the request; a process content acquisition unit configured to acquire a process content corresponding to the request item outputted from the request analysis unit, and configured to receive a next output from the request analysis unit in the absence of the process content corresponding to the request item; and an executing unit configured to execute a process corresponding to the request item.

### BACKGROUND OF THE INVENTION

1. Field of the Invention

The present invention generally relates to image forming apparatuses and image forming systems.

2. Description of the Related Art

Technologies are currently available to upgrade firmware in apparatuses connected via a network. For example, Japanese Laid-Open Patent Application No. 2004-139572 discloses a remote management system in which firmware in image forming apparatuses is updated at a predetermined date or time in order to prevent a decrease in the operating rate of the image forming apparatuses.

In another example, Japanese Laid-Open Patent Application No. 2004-252704 discloses a device management apparatus for coordinating the version or the like of software installed on devices connected via a network.

However, these technologies do not take into consideration version differences that cannot be addressed by the simple updating of software, such as firmware. For example, when a request is made in a format including a new function implemented in a new version of apparatus and transmitted to an older version of apparatus that does not have the new function, there has been the problem that the apparatus of the older version cannot process portions of the request excluding the new function, much less the portions involving the new function.

In order to overcome this problem, a request could be generated in a format adapted to each version of the apparatus. However, providing a client apparatus that generates requests adapted to individual versions leads to cost increases or management complexities when, for example, plural versions of image forming apparatuses are used within a single office environment.

Furthermore, in the aforementioned technologies, no consideration is given to the ease of adding a new function to an image forming apparatus. For example, when a new function is added in an image forming apparatus, if firmware for performing central control to output instructions concerning the functions of the apparatus is updated in addition to updating firmware for realizing the functions so that a process associated with the new function can be performed, management and/or development of firmware that is upgraded each time a new function is added or a combination of functions is modified becomes troublesome.

### SUMMARY OF THE INVENTION

It is therefore a general object of the present invention to provide an image forming apparatus and an image forming system in which the aforementioned problems are eliminated. A more specific object is to provide an image forming apparatus and an image forming system in which, when plural image forming apparatuses support different formats for a request, or when a new function is added in an image forming apparatus, the content of a request is analyzed and processed in an appropriate manner.

In one aspect, the invention provides an image forming apparatus comprising a communication unit configured to receive a request from a client apparatus in a predetermined description format; a request analysis unit configured to analyze the request to acquire and output a request item included in the request; a process content acquisition unit configured to acquire a process content corresponding to the request item outputted from the request analysis unit, and configured to receive a next output from the request analysis unit in the absence of the process content corresponding to the request item; and an executing unit configured to execute a process corresponding to the request item.

Thus, when plural image forming apparatuses support different formats for a request, the content of a request can be analyzed and processed in an appropriate manner in an image forming apparatus.

In another aspect, the invention provides an image forming apparatus comprising a list managing unit configured to manage a list of one or more function realizing units connected to the image forming apparatus; a communication unit configured to receive a request from a client apparatus in a first description format; a request analysis unit configured to analyze the request to acquire and output identifying information about the function realizing unit and a request item included in the request; a data format retaining unit configured to retain a data format for a process content corresponding to the request item for each of the function realizing units; and a process content acquisition unit configured to output, based on an output from the request analysis unit, the request item to the function realizing unit in the data format of the process content, and configured to output, in the absence of the process content corresponding to the function realizing unit, the request item to the function realizing unit in a second description format.

Thus, in an image forming apparatus to which a new function is added, the content of a request is analyzed and processed in an appropriate manner.

In other embodiments, the invention may provide an image forming system having the above image forming apparatus, an information processing method having steps for implementing individual units of the image forming apparatus or the image forming system, or a computer program for causing a computer to carry out the information processing method.

### BRIEF DESCRIPTION OF THE DRAWINGS

These and other objects, features and advantages of the invention will be apparent to those skilled in the art from the following detailed description of the invention, when read in conjunction with the accompanying drawings in which:

FIG. 1 shows an example of a conventional image forming system;

FIG. 2 shows another example of a conventional image forming system;

FIG. 3 shows an image forming apparatus according to an embodiment of the present invention;

FIG. 4 shows the image forming apparatus of FIG. 3 illustrating a process in which one request is processed by individual apparatuses;

FIG. 5 shows image forming apparatus in which different versions of requests are processed;

FIG. 6 illustrates a process in which a client PC receives responses from apparatuses;

FIG. 7 shows a structure of an image forming system according to an embodiment of the invention;

FIG. 8 shows a structure of an image forming apparatus according to an embodiment of the invention;

FIG. 9 shows a functional structure of an image forming system according to an embodiment;

FIG. 10 shows a sequence chart of a process based on a request from a client;

FIG. 11 shows a sequence chart of a process in which a response is transmitted based on a request from a client;

FIG. 12 shows a sequence chart of a process of transmitting a message based on an event;

FIG. 13 shows a flowchart of a process of analyzing a request;

FIG. 14 shows a flowchart of a process of generating a response or a message;

FIG. 15 shows an example of a request;

FIG. 16 shows an example of a response;

FIG. 17 shows another example of a response;

FIG. 18A shows an example of a message;

FIG. 18B shows another example of a message;

FIG. 19 illustrates a problem associated with the selection of request items;

FIG. 20 illustrates an example of transmitting an unknown request item;

FIG. 21 illustrates an example of transmitting an unknown response item;

FIG. 22 shows a functional structure of an image forming system according to an embodiment of the invention;

FIG. 23 shows a flowchart of a process of analyzing a request;

FIG. 24 shows an example of a request;

FIG. 25 illustrates how request items are converted into the second description format;

FIG. 26 shows a flowchart of a process of generating a response or a message;

FIG. 27 illustrates how a response is generated in the first description format based on response items in the second description format;

FIG. 28 shows an example of a response;

FIG. 29 shows another example of a response;

FIG. 30A shows an example of a message; and

FIG. 30B shows another example of a message.

### DETAILED DESCRIPTION OF THE PREFERRED EMBODIMENTS

In the following, embodiments of the present invention are described with reference to the drawings.

### (Request Made in a Conventional Image Forming System)

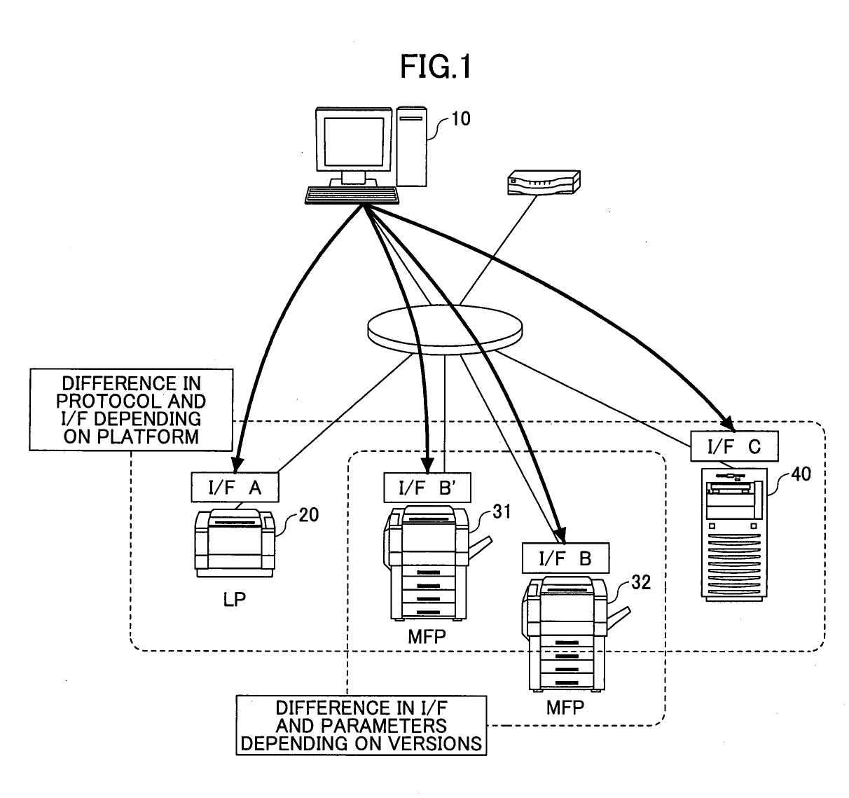

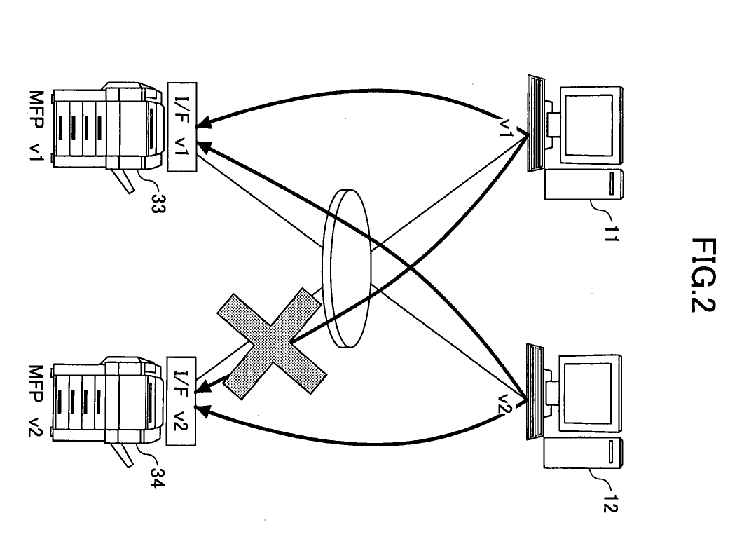

With reference to FIGS. 1 and 2, problems to be solved by an embodiment of the present invention are described. FIG. 1 shows an image forming system in which a laser printer (“LP”) 20, multifunction peripherals (“MFP”) 31 and 32, a copy machine 40, and a personal computer (“PC”) 10 as a client apparatus are connected via a network. The MFP 31 and the MFP 32 are of different versions, so that they have different interfaces and request parameters, for example. The LP 20, the MFP 31, and the copy machine 40 have different platforms, so that they have different communication protocols and interfaces.

The PC 10, which manages the other apparatuses in the system, may access each of the apparatuses by the following two methods:

1. Use the Simple Network Management Protocol (SNMP) to access information in a management information base (MIB).

2. Use the Simple Object Access Protocol (SOAP) or XML data on the Hyper Text Transfer Protocol (HTTP).

In Method 1, although information defined by the MIB can be accessed and acquired by all of the apparatuses, information other than the MIB cannot be acquired. On the other hand, in Method 2, information in any of the apparatuses can be accessed by defining interface for the individual apparatus, using SOAP or XML. However, in Method 2, when the interface is different due to a difference in platform or version, a process adapted to the difference is required on the side of the PC 10.

In the present embodiment, the term “interface” is intended to refer to a “network interface” unless otherwise specified. It may be information, such as a Universal Resource Locator (URL), for identifying and calling an apparatus in SOAP.

FIG. 2 shows an image forming system in which MFPs 33 and 34 and client PCs 11 and 12 are connected via a network. The MFP 33 and the PC 11 are compatible with Version 1, which is an older version, while the MFP 34 and the PC 12 are compatible with Version 2, which is a new version.

In FIG. 2, the PC 12 is also compatible with the interface of the older product MFP 33, and it can therefore access information in the MFP 33 as well as in the MFP 34. On the other hand, the PC 11 is not compatible with the interface of the older product MFP 34, so that it can access information in the MFP 33 but not information in the MFP 34.

### (Request and Response in an Image Forming System)

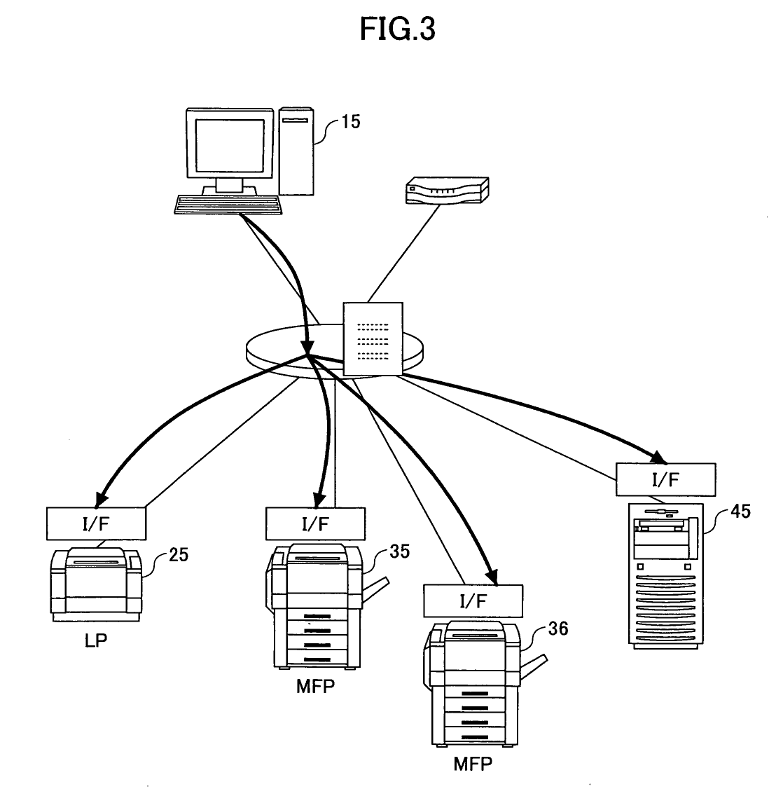

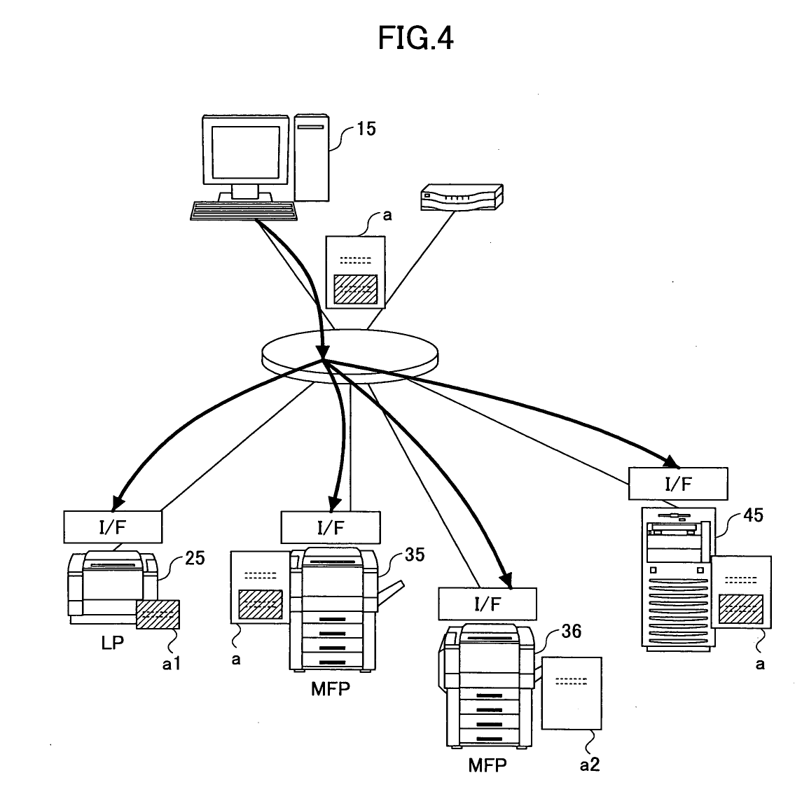

With reference to FIGS. 3 through 6, an image forming system according to an embodiment of the present invention is described. FIGS. 3 and 4 show the image forming system, in which a PC 15 as a client apparatus is connected with an LP 25, MFPs 35 and 36, and a copy machine 45 via a network.

In FIG. 3, the LP 25, the MFPs 35 and 36, and the copy machine 45 have the same interface, and use the same protocol for the transmission and reception of requests and responses.

With reference to FIG. 4, a process of analyzing a request transmitted by the PC 15 in each of the rest of the apparatuses in the image forming system of FIG. 3 is described. In FIG. 4, the request may have an XML format. Of the request items contained in the request, only a request item corresponding to the function of an individual apparatus is processed in each apparatus.

For example, of a request a transmitted from the PC 15, the LP 25 processes a request item a1 corresponding to the function of the LP 25. Similarly, the MFP 36 processes a request item a2 corresponding to its own function. Because the MFP 35 and the copy machine 45 have functions compatible with all of the request items in the request a, they process all of the request items.

Thus, the PC 15 can output a request without considering the functions of the other individual apparatuses, so that the need to modify the function of the client depending on the function or version of an individual apparatus can be eliminated.

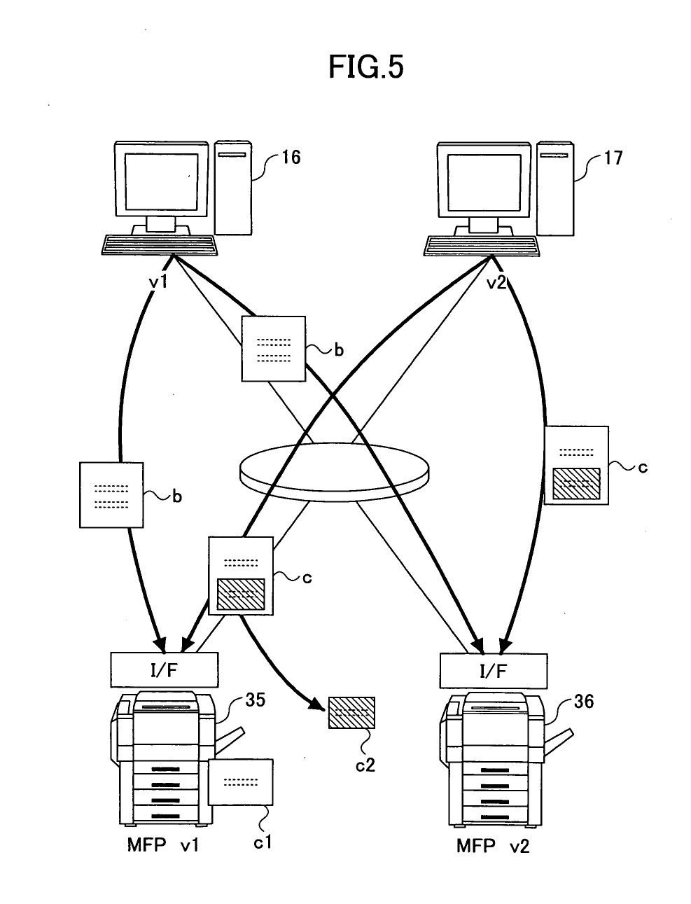

FIG. 5 shows an image forming system including two client PCs of different versions. In this image forming system, PCs 16 and 17 are connected to MFPs 35 and 36 via a network. The PC 16 and the MFP 35 are compatible with Version 1, which is an older version, while the PC 17 and the MFP 36 are compatible with Version 2, which is a new version.

The PC 16 outputs a request b to the MFPs 35 and 36 in a data format compatible with the older version. On the other hand, the PC 17 outputs a request c to the MFPs 35 and 36 in a data format compatible with the new version.

The MFP 36 processes all of the request items contained in each of the requests b and c. On the other hand, while the MFP 35 can process all of the request items contained in the request b, it cannot process a request item c2 in the request c that is adapted to Version 2. Thus, the MFP 35 processes only a request item c1 corresponding to Version 1.

Thus, because the request description format is unified, the client PC can transmit a request without considering the versions of the MFPs or the client PC itself, and the MFPs can process the items contained in the request.

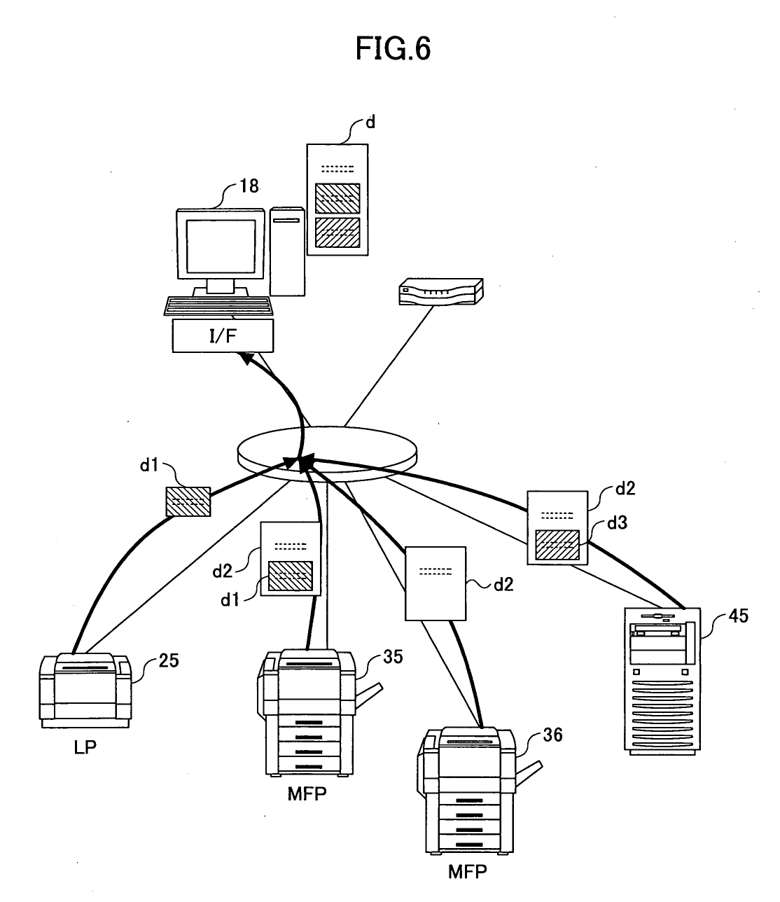

With reference to FIG. 6, a client PC that receives responses from various apparatuses is described. In FIG. 6, a PC 18 is connected to a LP 25, MFPs 35 and 36, and a copy machine 45 via a network. Each of the apparatuses outputs a response to the PC 18 after performing a process corresponding to a request.

The LP 25 outputs a response d1, the MFP 35 outputs a response d2 including the response d1, the MFP 36 outputs a response d2, and the copy machine 45 outputs a response d2 including the response d3. Although the content of each response is different, the description format is unified. The PC 18 can manage the status of each apparatus by processing a response d that includes all of the responses d1 to d3.

### (System Structure)

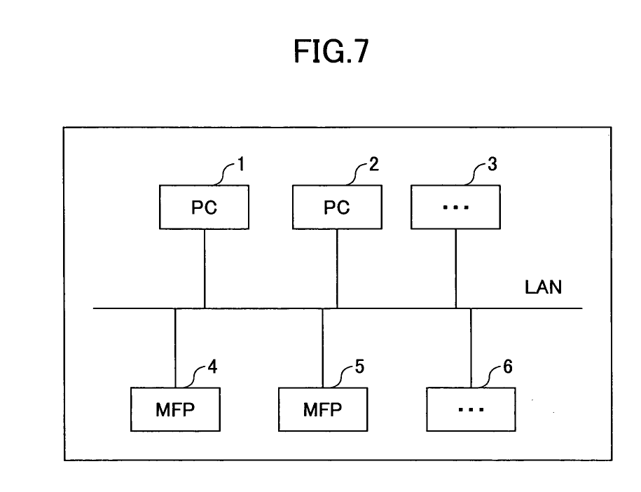

FIG. 7 shows an example of a structure of the image forming system according to the present embodiment. In this image forming system, PCs 1, 2, 3, . . . , and MFPs 4, 5, 6, . . . , are connected to a local area network (LAN). Each PC can output a request to and receive a response from any of the MFPs.

### (Structure of MFP)

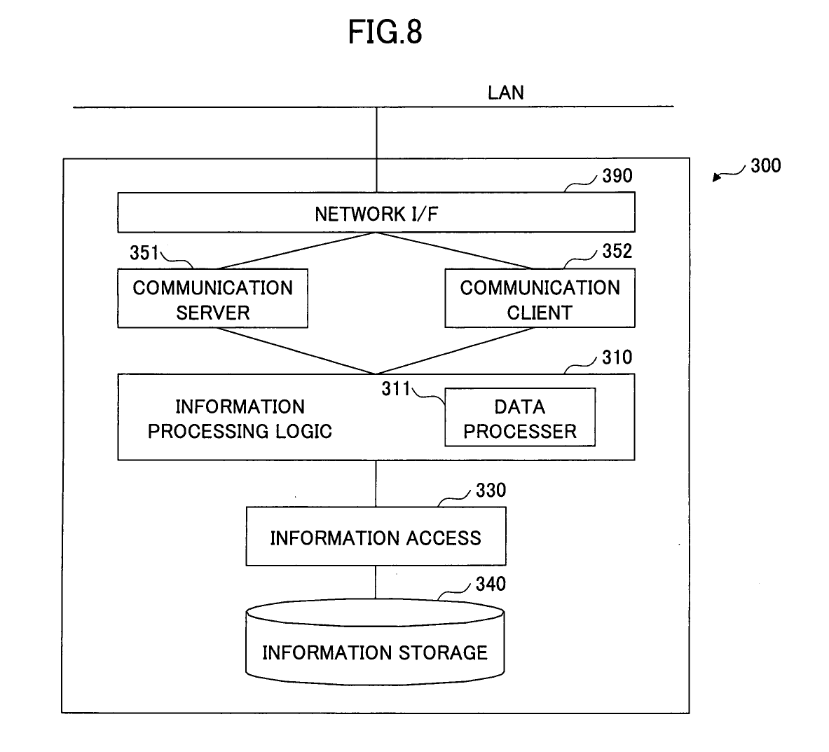

FIG. 8 shows an example of the structure of an MFP 300 as an image forming apparatus in the present embodiment. The MFP 300 includes an information processing logic unit 310, an information access unit 330, an information retaining unit 340, a communication server unit 351, a communication client unit 352, and a network interface (“I/F”) 390.

The information processing logic unit 310 analyzes a request from a client apparatus or the like, and generates a response to the client apparatus or the like. The information processing logic unit 310 includes a data processing unit 311. The data processing unit 311 parses the request described in XML, and generates a response described in XML.

The information access unit 330, based on a request item contained in the request analyzed by the information processing logic unit 310, either acquires information retained in the information retaining unit 340, edits and replaces the information, or generates information and stores it in the information retaining unit 340. The information retaining unit 340 may store the status of the image forming apparatus 300, identifying information about each operator, and image data.

The communication server unit 351 and the communication client unit 352 communicate with the client apparatus. The network I/F 390 provides an interface for connecting the image forming apparatus 300 with the LAN.

### (Functional Structure of the Image Forming System)

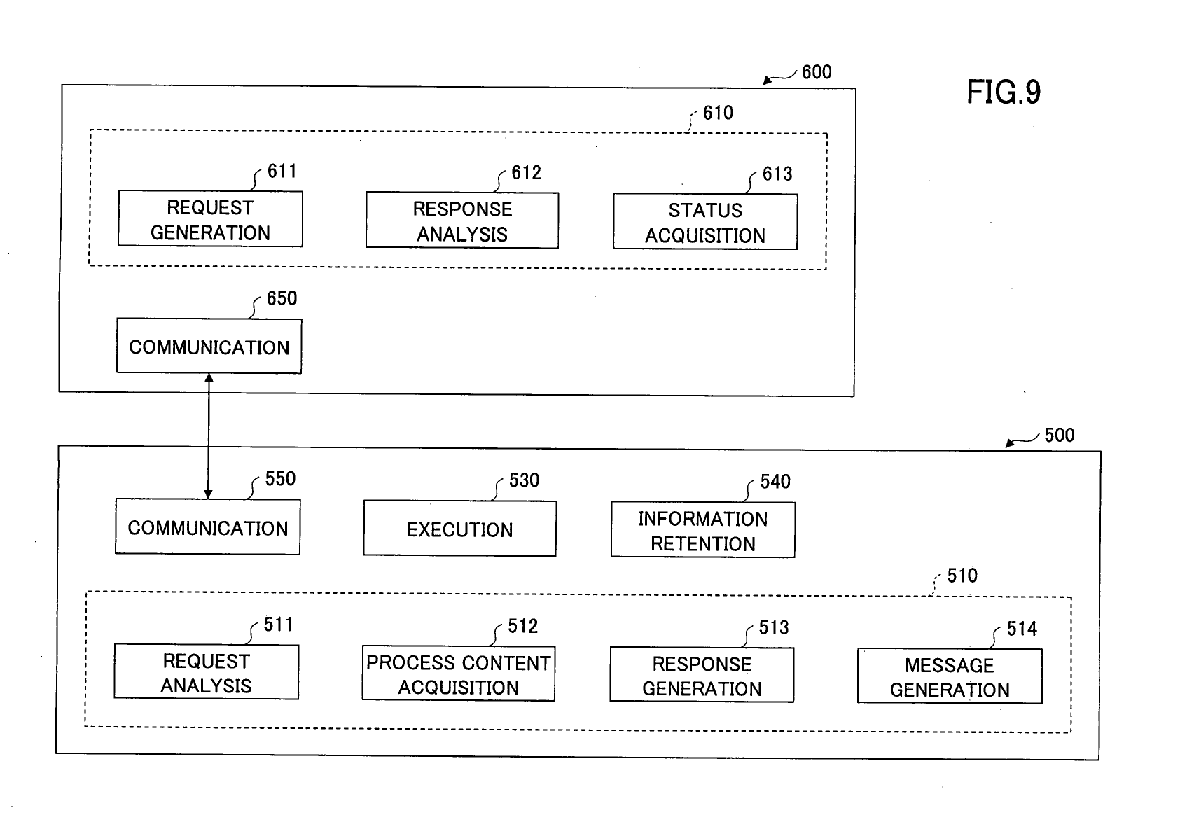

FIG. 9 shows a functional structure of the image forming system according to the present embodiment. In this example, an image forming apparatus 500 and a client PC 600 are connected, either directly or via a network.

The image forming apparatus 500 includes an information processing logic unit 510, an executing unit 530, an information retaining unit 540, and a communication unit 550. The information processing logic unit 510 analyzes a request transmitted from the client PC 600 and acquires a request item contained therein. The information processing logic unit 510 also generates a response corresponding to the request item.

The information processing logic unit 510 includes a request analysis unit 511, a process content acquisition unit 512, a response generation unit 513, and a message generation unit 514. The request analysis unit 511 analyzes a request in accordance with its syntax. The request analysis unit 511 may be structured as an XML parser. Thus, a request item contained in the request can be acquired.

The process content acquisition unit 512, based on the content analyzed by the request analysis unit 511, acquires a process content corresponding to the request item. When the process content corresponding to the request item cannot be acquired, the process content acquisition unit 512 processes the next request item without performing a process for the present request item.

Thus, the image forming apparatus 500 can process a request item contained in the request that it can process and not process other request items even when the request is based on a different version, as long as the description format is unified.

The response generation unit 513 generates a response corresponding to the processed request item. The response generated by the response generation unit 513 may be based on the version of the image forming apparatus 500.

The message generation unit 514, based on a predetermined event in the image forming apparatus 500, generates a message in which information about the status of the image forming apparatus 500 is described in a predetermined description format. The predetermined event may be the occurrence of an error in the image forming apparatus 500, such as the opening of a door, or the absence of sheets.

The executing unit 530, based on the request item acquired by the process content acquisition unit 512, executes the corresponding process. The executing unit 530 may acquire information stored in the information retaining unit 540 and output it. The executing unit 530 may edit and replace information saved in the information retaining unit 540. Or it may generate new information based on the request item and store it in the information retaining unit 540. The executing unit 530 may, in addition to processing the information in the information retaining unit 540, also perform a process relating to various functions of the image forming apparatus 500, such as an image formation function, a communication function, and a facsimile function.

The information retaining unit 540 retains information about the status of the image forming apparatus 500. It may also retain image data of an image processed by the image forming apparatus 500, or information about an operator of the image forming apparatus 500. The communication unit 550 communicates with the client PC 600 to receive a request or transmit a response or a message, for example.

The client PC 600 transmits a request to the image forming apparatus 500 and receives a response therefrom. Thus, the client PC 600 controls the image forming apparatus 500 and manages the information possessed by the image forming apparatus 500.

The client PC 600 includes an information processing logic unit 610 and a communication unit 650. The information processing logic unit 610 generates a request transmitted to the image forming apparatus 500. It also analyzes a response transmitted from the image forming apparatus 500. In this way, the status of the image forming apparatus 500 can be acquired. The term “status” herein may refer to the information retained n the image forming apparatus 500, as well as the status of the image forming apparatus 500.

The information processing logic unit 610 includes a request generation unit 611, a response analysis unit 612, and a status acquisition unit 613. The request generation unit 611 generates a request including a request item requested from the image forming apparatus 500.

The response analysis unit 612 analyzes a response transmitted from the image forming apparatus 500. The response analysis unit 612 may be structured as an XML parser when the response is described in XML. The status acquisition unit 613 acquires the status of the image forming apparatus 500 based on the response item analyzed by the response analysis unit 612.

### Example 1 of a Process Based on a Request from Client

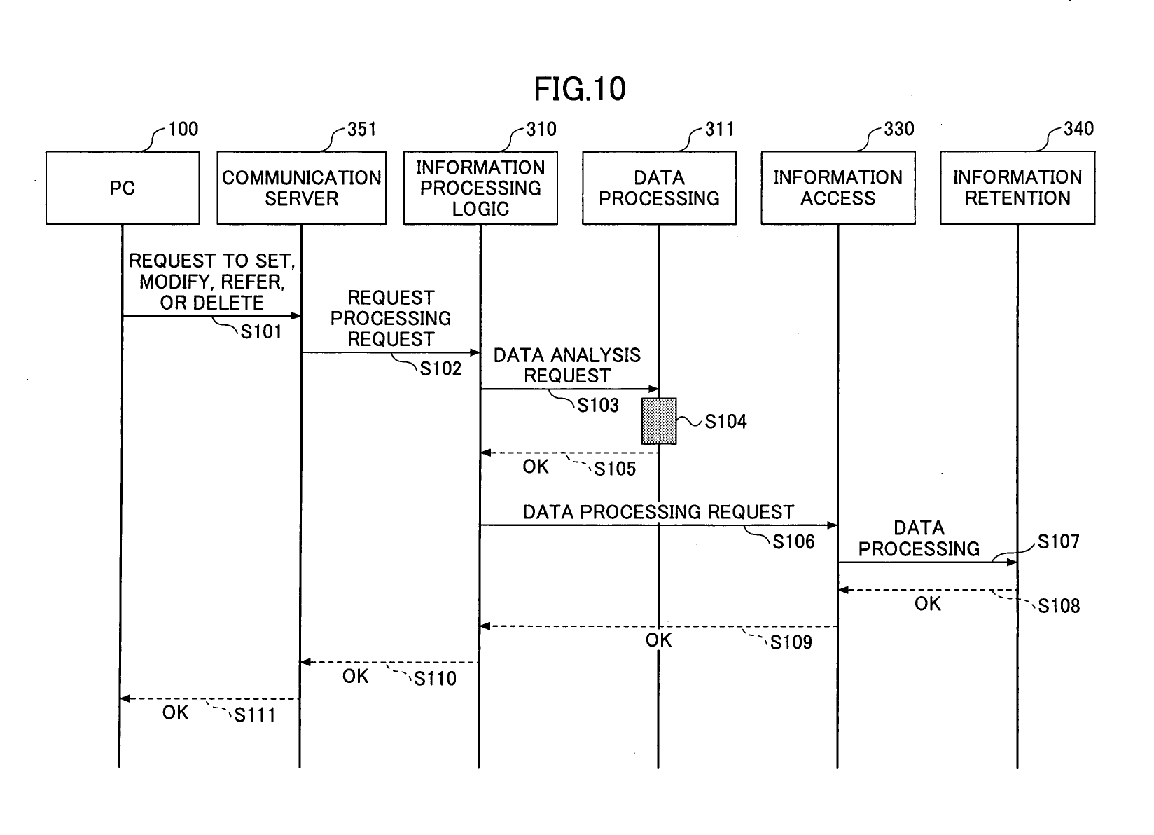

FIG. 10 shows a sequence chart of a process based on a request from a client that is performed in the image forming apparatus 300. In step S101, a PC 100 transmits a request to the communication server unit 351. The request may include request items for setting a condition, or referring, modifying, or deleting information. The request may be transmitted as an HTTP request.

In step S102, the communication server unit 351 outputs a request to the information processing logic unit 310 to process the request received in step S101. The received request may be a request to manipulate data in an address book retained in the information retaining unit 340 of the image forming apparatus 500.

In step S103, the information processing logic unit 310 outputs a request to the data processing unit 311 to analyze the request data.

In step S104, the data processing unit 311 analyzes the request and acquires a request item contained in the request. The request may be described in accordance with the Atom Publishing Protocol (“APP”), Atom, or other extended description format. Thus, the data processing unit 311 acquires the request item in accordance with each description format, and then acquires a process content corresponding to the request item.

In step S105, the data processing unit 311 outputs the acquired request item and a notice that the analysis of the request is complete, to the information processing logic unit 310. Thus, the information processing logic unit 310 acquires the process content corresponding to each request item.

In step S106, the information processing logic unit 310 outputs a request to the information access unit 330 to execute the process content. In step S107, the information access unit 330 accesses the information retaining unit 340, whereby a process based on the request received in step S101 is performed.

In step S108, the information processing unit 340 outputs a notice to the information access unit 330 indicating the end of process. In step S109, the information access unit 330 outputs a notice to the information processing logic unit 310, indicating the end of process. In step S110, the information processing logic unit 310 outputs a request to the communication server unit 351 to notify the PC 100 of the end of process. In step S111, the communication server unit 351 transmits a notice to the PC 100 indicating the end of process in the form of an HTTP response, for example.

### Example 2 of Process Based on a Request from Client

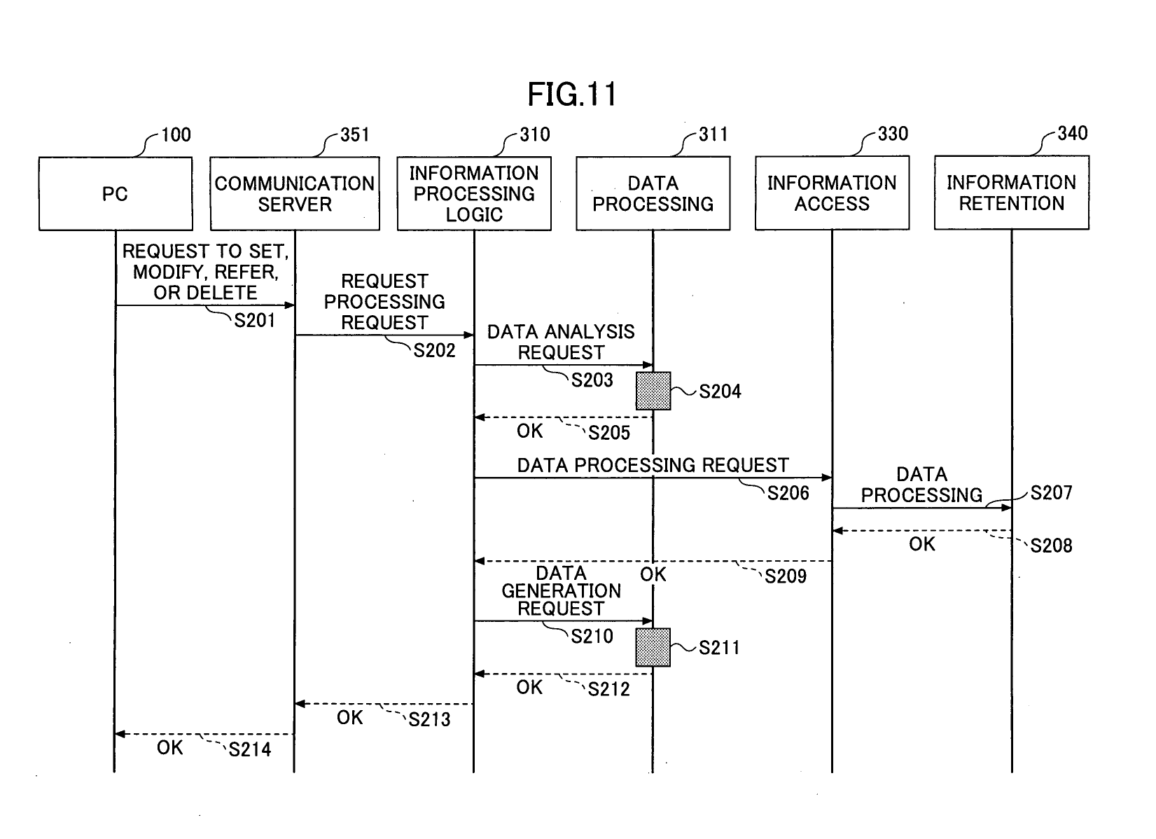

FIG. 11 shows a sequence chart for a process based on a request from a client that is performed in the image forming apparatus 300. In this example, the image forming apparatus 300 transmits a response to the PC 100. Steps S201 through S209 are the same as steps S101 through S109 of FIG. 10, and therefore their description is omitted herein.

In step S210, the information processing logic unit 310 outputs a request to the data processing unit 311 to generate a response. In step S211, the data processing unit 311 generates a response including a response item corresponding to each process content processed in step S204, for example. The response is described in a predetermined description format, and may be described in XML. More Specifically, it may be described in APP, Atom, or other extended format. Which format is used for description depends on, for example, the described content of the request indicating a desired format for response, or the formats supported by the image forming apparatus.

In step S212, the data processing unit 311 outputs a notice of the end of generation of response and the response, to the information processing logic unit 310. The output of the response may double as the notice of the end of generation of a response.

In step S213, the information processing logic unit 310 outputs the response and a request to transmit the response, to the communication server unit 351. In step S214, the communication server unit 351 transmits the response to the PC 100.

### (Process of Generating and Transmitting a Message)

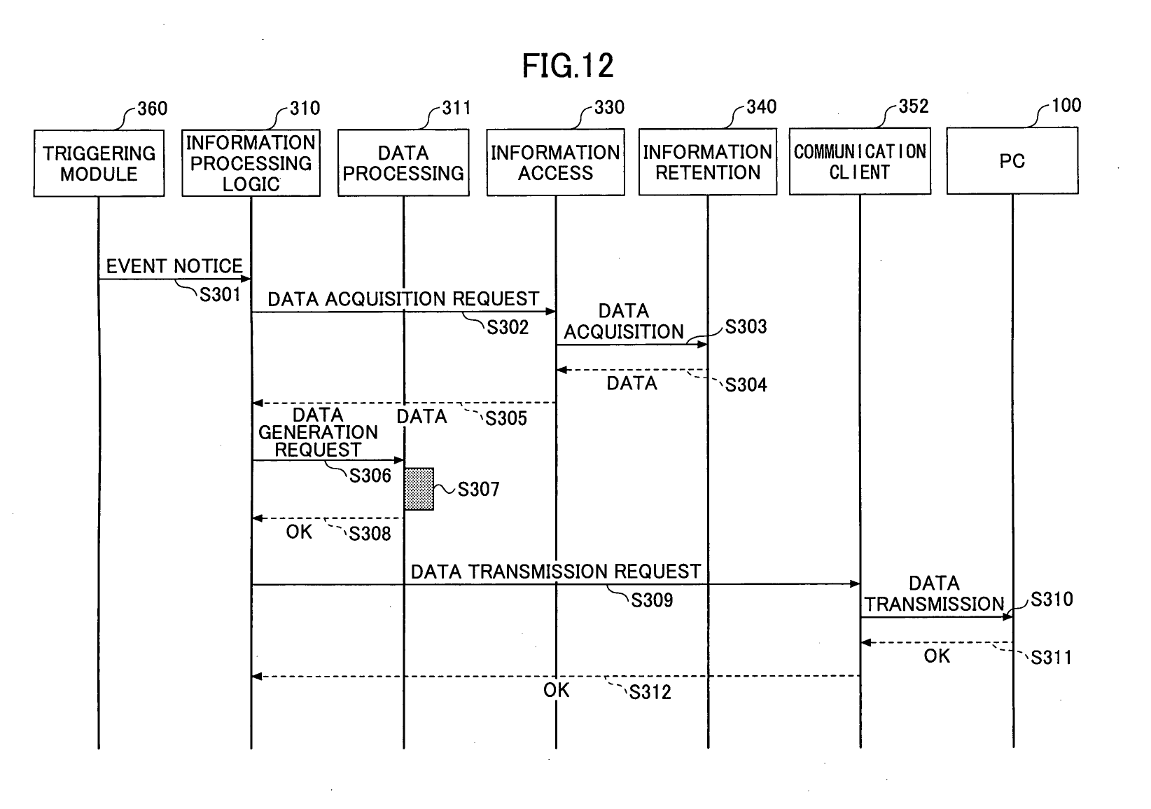

FIG. 12 shows a sequence chart for a process in which the image forming apparatus 500 transmits a message based on a predetermined event to the PC 100. In step S301, a triggering module notifies the information processing logic unit 310 of the occurrence of an event. The event may be the occurrence of abnormality, such as the opening of a door in the image forming apparatus 500.

In step S302, the information processing logic unit 310 outputs a data acquiring request to the information access unit 330. This is because the content in the notice made in step S301 is information indicating the occurrence of an event of which the details can be obtained by referring to the information retained in the information retaining unit 340.

In step S303, the information access unit 330 outputs a data acquisition request to the information retaining unit 340. In step S304, the information retaining unit 340 outputs data to the information access unit 330. The data includes detailed information about the event. In step S305, the information access unit 330 outputs the data acquired in step S304 to the information processing logic unit 310.

In step S306, the information processing logic unit 310 outputs a message generating request to the data processing unit 311. In step S307, the data processing unit 311 generates a message based on the detailed information about the event contained in the data. The message is expressed in a predetermined description format. In step S308, the data processing unit 311 outputs the message and a notice that the preparation of the message is complete, to the information processing logic unit 310. The output of the message may double as the notice of completion of the preparation of the message.

In step S309, the information processing logic unit 310 outputs a message transmission request to the communication client unit 352. In step S310, the communication client unit 352 outputs the message to the PC 100. The message may be transmitted as an HTTP request.

In step S311, the PC 100 transmits a notice of reception of the message to the communication client unit 352 in the form of an HTTP response, for example. In step S312, the communication client unit 352 outputs a notice of reception of the message to the information processing logic unit 310.

### (Request Analyzing Process)

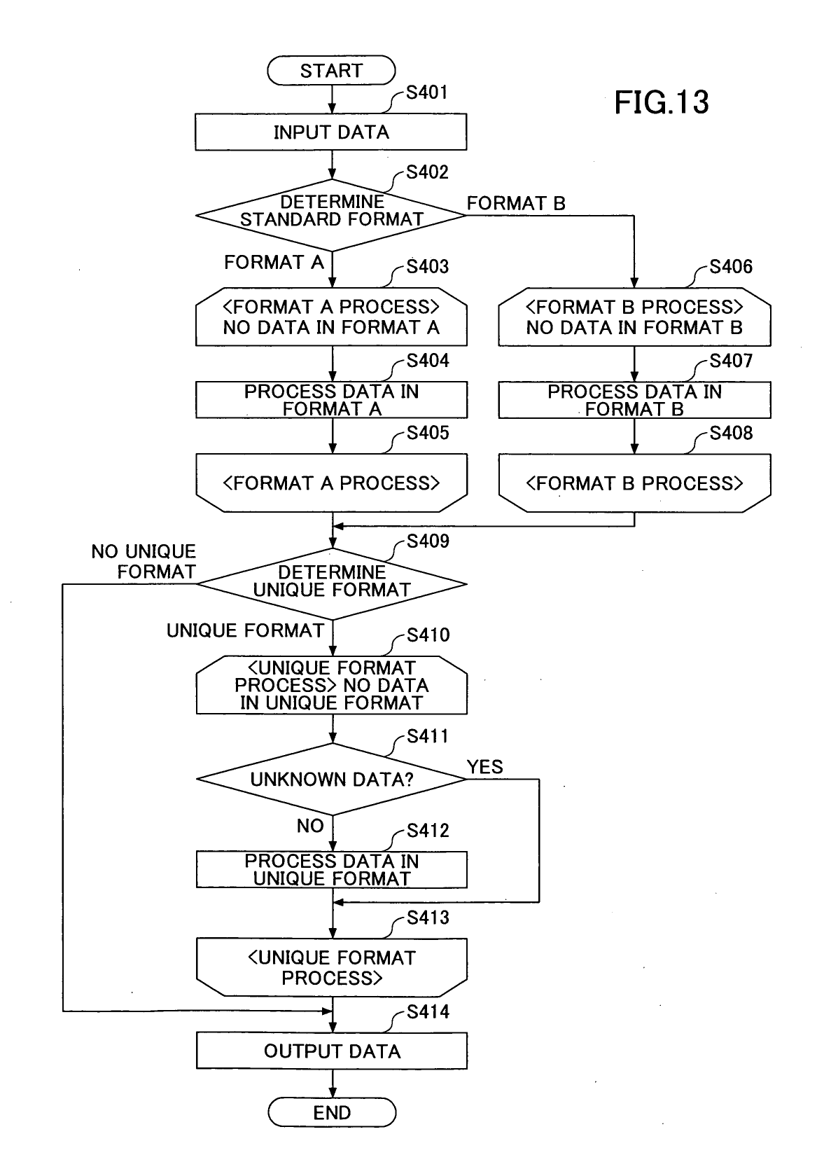

FIG. 13 shows a flowchart of an example of a process of analyzing a request in the information processing logic unit 310 and the data processing unit 311. The process of FIG. 13 may be performed by the request analysis unit 511 in step S104 of FIG. 10 or in step S204 of FIG. 11. With reference to FIG. 13, in step S401, a request is entered into the data processing unit 311. In step S402, the request analysis unit 511 analyzes the request from its heading to determine its standard format portion. Specifically, it is determined whether the standard format is format A or format B. If it is format A, the routine proceeds to step S403; if it is format B, the routine proceeds to step S406.

The term “standard format” may refer to a general standard such as the APP or Atom when the request is described in XML. While one of two standard formats is processed in the present embodiment, one or more standard formats out of three or more standard formats may be processed in another embodiment.

In steps S403 to S405, with regard to the portion described in format A, the request analysis unit 511 acquires a request item, and the process content acquisition unit 512 acquires a process content corresponding to the request item. This process is repeated until all of the portions described in format A are processed. When there is no process content corresponding to the request item, the process content acquisition unit 512 performs no process with regard to the request item and proceeds to the processing of the next request item.

Thus, even when there is a request item in the request that does not correspond to the function of the image forming apparatus 500, the image forming apparatus 500 can process only those request items that correspond to its function. Therefore, a client apparatus or the like that generates a request can output the same request to a plurality of image forming apparatuses of different versions.

On the other hand, in steps S406 to S408, with regard to a portion described in format B, the request analysis unit 511 and the process content acquisition unit 512 perform a process similar to the process in steps S403 to S405.

After the portions described in the standard format are processed, a unique format process is initiated. In step S409, the request analysis unit 511 determines the presence or absence of a unique format in the request. If there is the unique format in the request, the routine proceeds to step S410; if there is no unique format, the routine proceeds to step S414. The determination in step S409 may be based on the presence or absence of a group of request items that corresponds to the processing function of the image forming apparatus 500, instead of on the presence or absence of the unique format. If there is such a group of request items that corresponds to the processing function of the image forming apparatus 500, the routine proceeds to step S410; if there is not, the routine proceeds to step S414.

In steps S410 to S413, the request analysis unit 511 repeats the process of acquiring the request items contained in the request until all of the request items are acquired. Each time a request item is acquired, the process content acquisition unit 512 in step S411 determines the presence or absence of a process content corresponding to the request item. If there is the corresponding process content, the process content acquisition unit 512 acquires the process content in step S412. If there is no corresponding process content, the routine proceeds to step S413.

After step S409 or step S413, the routine proceeds to step S414, where the acquired process content is outputted to the information processing logic unit 310.

### (Generation of Response or Message)

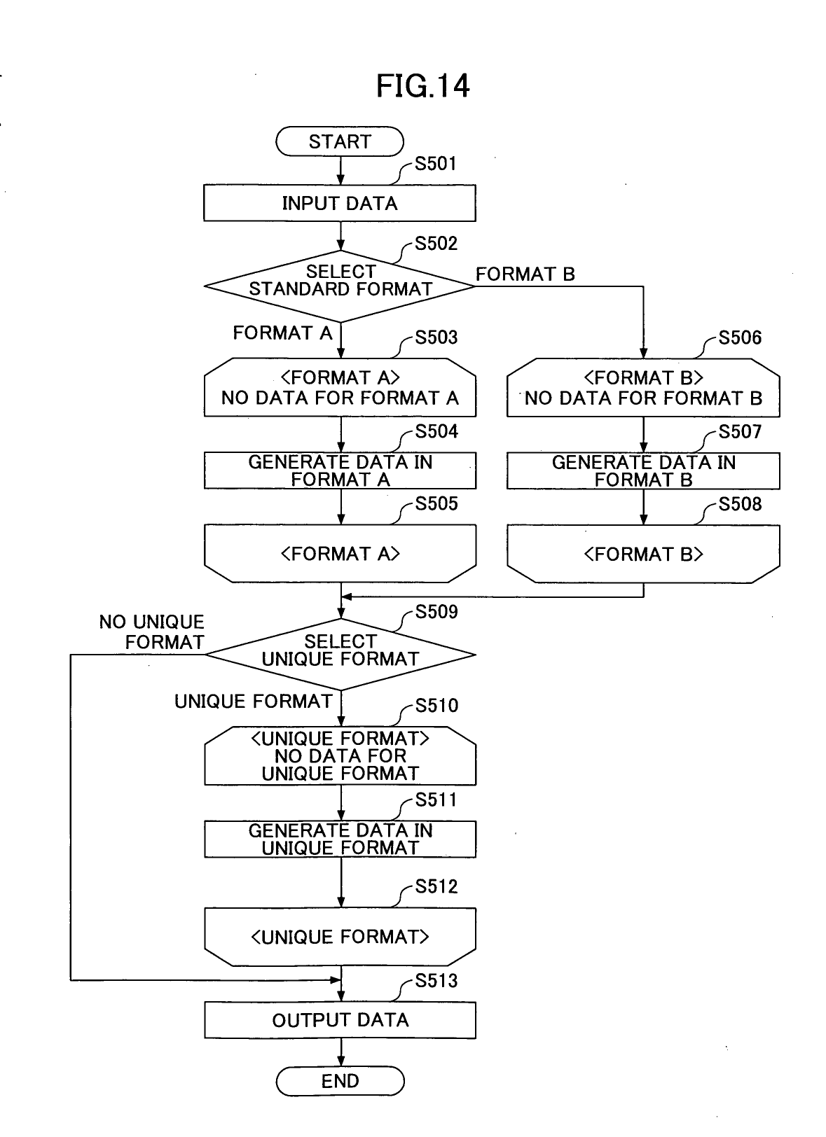

FIG. 14 shows a flowchart of a process of generating a response or a message in the information processing logic unit 310 and the data processing unit 311. The process of FIG. 14 may be performed by the response generation unit 513 in step S211 of FIG. 11, or it may be performed by the message generation unit in step S307 of FIG. 12. The example described below involves a process performed by the response generation unit 513.

With reference to FIG. 14, in step S501, the information processing logic unit 310 enters data for a response item contained in a response into the data processing unit 311. In step S502, the response generation unit 513, based on the entered data, selects a response description format. In the present example, a standard format portion is selected and, when describing in format A, the routine proceeds to step S503; when describing in format B, the routine proceeds to step S506.

While one of two standard formats is selected in the present example, one or more standard formats may be selected from plural standard formats to generate a response described in one or more of the selected standard formats.

In steps S503 to S505, the response generation unit 513 generates data for response items described in format A until there is no response item data described in format A. On the other hand, similarly in steps S506 to S508, data for response items described in format B is generated until there is no response item data described in format B.

In step S509, the response generation unit 513 determines the presence or absence of response item data described in a unique format. If there is response item data described in the unique format, the routine proceeds to step S510; if there is not, the routine proceeds to step S513.

In steps S510 to S512, the response generation unit 513 repeats the process of describing the response item in the unique format until there is no response item data described in the unique format.

In step S513, the response generated by the response generation unit 513 is outputted to the information processing logic unit 310.

### (Protocol, Interface, and Description Format)

In the present embodiment, the interface of the image forming apparatuses with which the client PC communicates should desirably be unified, so that the client PC can communicate with them without being aware of the interface of the individual image forming apparatus. Similarly, the protocol and the data description format should desirably be unified.

The following are examples of protocols, interfaces, and description formats used in the present embodiment:

Protocol: HTTP, APP

Interface: HTTP POST, GET, PUT, or DELETE

Description format: APP, Atom, and other extended format

Other than those mentioned above, the following combinations may be possible.

### Example 1

Protocol: HTTP, SOAP

Interface: Unique format

Description format: SOAP, unique format

### Example 2

Protocol: HTTP

Interface: Unique format

Description format: Uniquely extended XML

### (Request and Response)

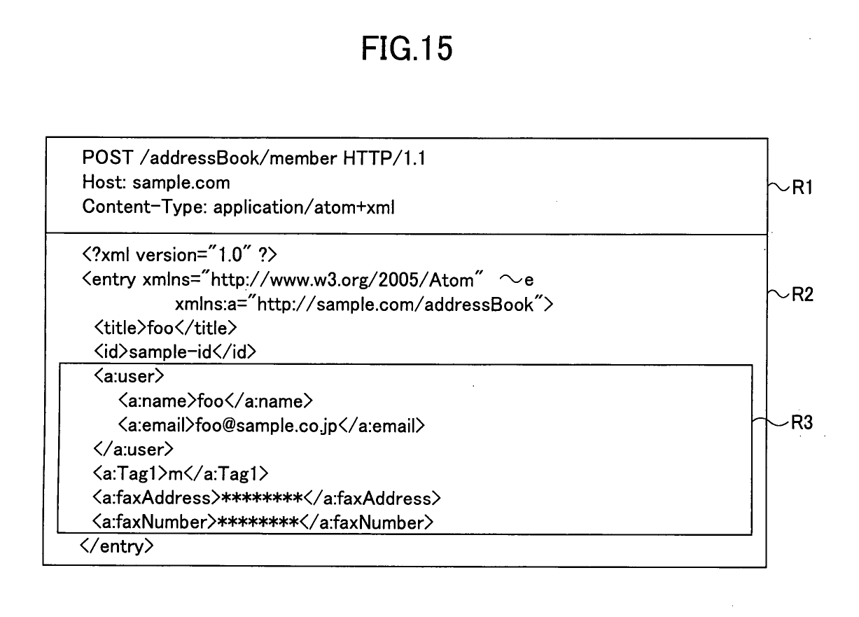

FIG. 15 shows an example of a request to add new record in an address book retained in the information retaining unit 540 of the image forming apparatus 500. The request of FIG. 15 includes an HTTP request header portion R1 and a main body R2 containing a request item. In the main body R2, the description in a portion indicated by the letter e indicates that the request is described in Atom and an extended format defined by a namespace “a”. R3 is a portion described in the extended format.

R3 includes information about records, such as mail address and a facsimile number corresponding to the name “foo,” as individual request items.

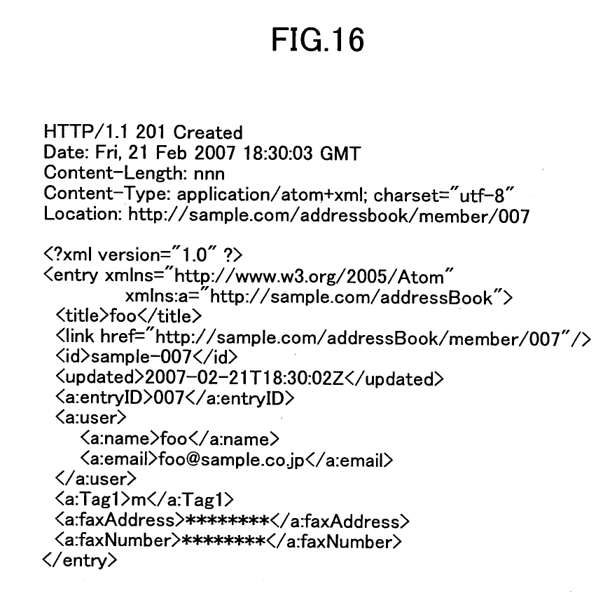

FIG. 16 shows an example of a response generated corresponding to the request of FIG. 15. In FIG. 16, the content processed based on the request of FIG. 15 is included. Namely, the content of the record added to the address book, i.e., the name “foo” and the corresponding mail address, facsimile number, and the like, is contained as individual response items.

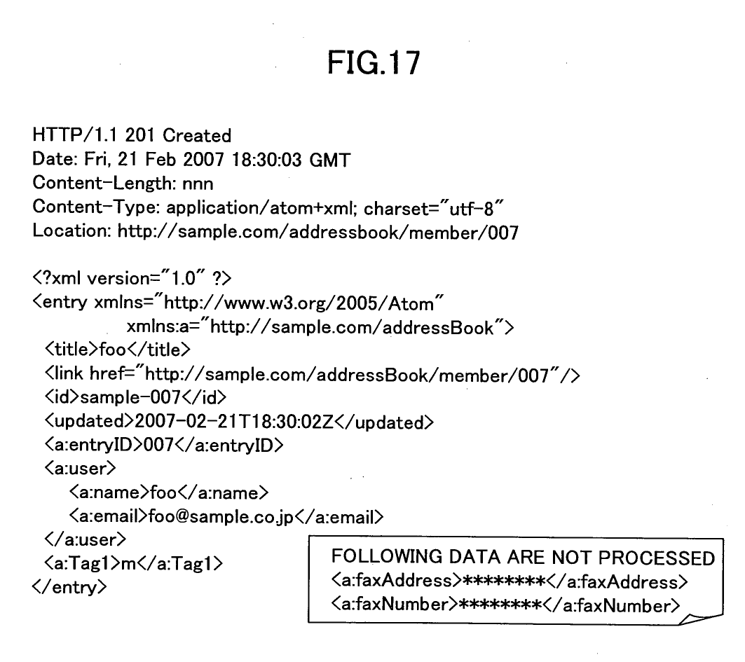

FIG. 17 shows an example of a response generated corresponding to the request of FIG. 15, which is different from the response of FIG. 16. The response of FIG. 17 does not include response items corresponding to “faxAddress” and “faxNumber.” This is because the image forming apparatus that generated this response does not have the function of adding such information to the address book.

When editing the data in the address book, HTTP PUT may be used to enter a request and output a corresponding response. When referring to data in the address book, HTTP GET may be used to output response data. Further, when deleting data in the address book, HTTP DELETE may be used without involvement of exchange of request and response data.

### (Message)

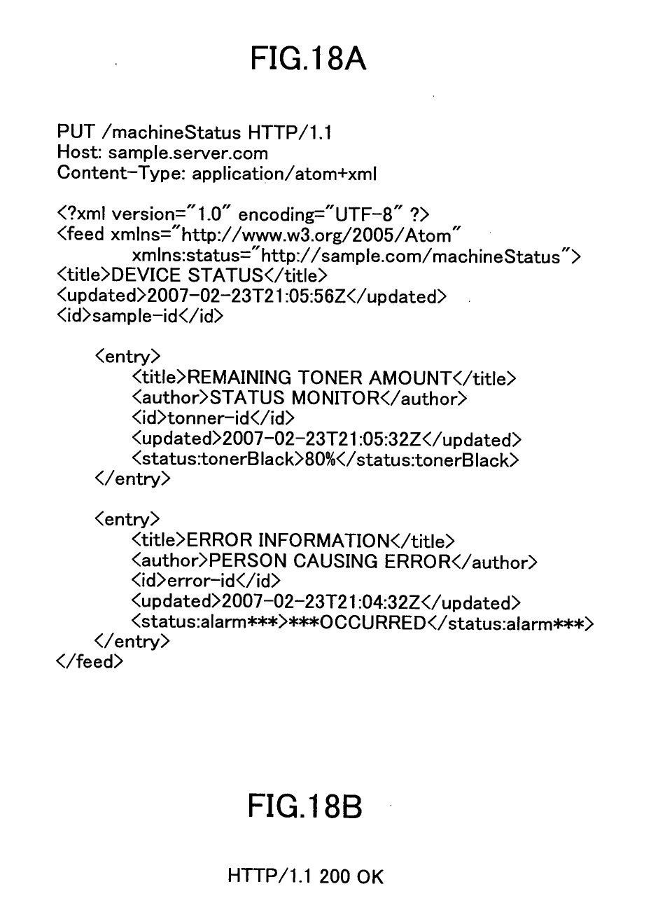

FIG. 18A shows an example of a message to notify the client PC of an occurrence of abnormality in the image forming apparatus. FIG. 18B shows a response to the message outputted by the client PC. In the examples shown, the message is transmitted as an HTTP request, and the response is returned as an HTTP response.

In the following, another embodiment of the present invention is described.

### (Processing of a Request by Individual Apparatuses)

In the image forming system shown in FIG. 4, one request is processed by each of plural apparatuses.

In this image forming system, the PC 15 as a client apparatus is connected to the LP 25, the MFPs 35 and 36, and the printing machine 45, via a network. The LP 25, the MFPs 35 and 36, and the printing machine 45 have the same interface, and use the same protocol for the transmission and reception of requests and responses.

In the image forming system of FIG. 4, request data may be in an XML format. Of the request items contained in a request, only a request item that corresponds to the function realizing unit of each apparatus is processed in each apparatus.

For example, with regard to a request a transmitted from the PC 15, the LP 25 processes a request item a1 that corresponds to the function realizing unit of the LP 25. Similarly, the MFP 36 processes a request item a2 corresponding to its own function realizing unit. Because each of the MFP 35 and the printing machine 45 has function realizing units corresponding to all of the request items contained in the request a, they process all of the request items. Such selection of request items may be carried out in a Web Service (“WS”) unit of each apparatus.

Thus, the PC 15 can output a request without considering the function realizing unit of each apparatus, so that the need to modify the function realizing unit of the client depending on the function realizing unit or the version of each apparatus can be eliminated.

The PC 15 may access each apparatus in the following two methods:

1. Use Simple Network Management Protocol (SNMP) to access information in a management information base (MIB).
2. Use Simple Object Access Protocol (SOAP) or XML data over the Hyper Text Transfer Protocol (HTTP).

In Method 1, although information defined by the MIB can be accessed and acquired by all of the apparatuses, information other than the MIB cannot be acquired. On the other hand, in Method 2, information in an apparatus can be accessed by defining interface for each apparatus, using SOAP or XML. However, in Method 2, when the interface is different due to a difference in platform or version, a process adapted to the difference is required on the side of the PC 15.

In the present embodiment, the term “interface” is intended to refer to a “network interface” unless otherwise specified. It may be information, such as a Universal Resource Locator (URL), for identifying and calling an apparatus in SOAP.

(Problems Associated with the Selection of a Request Item)

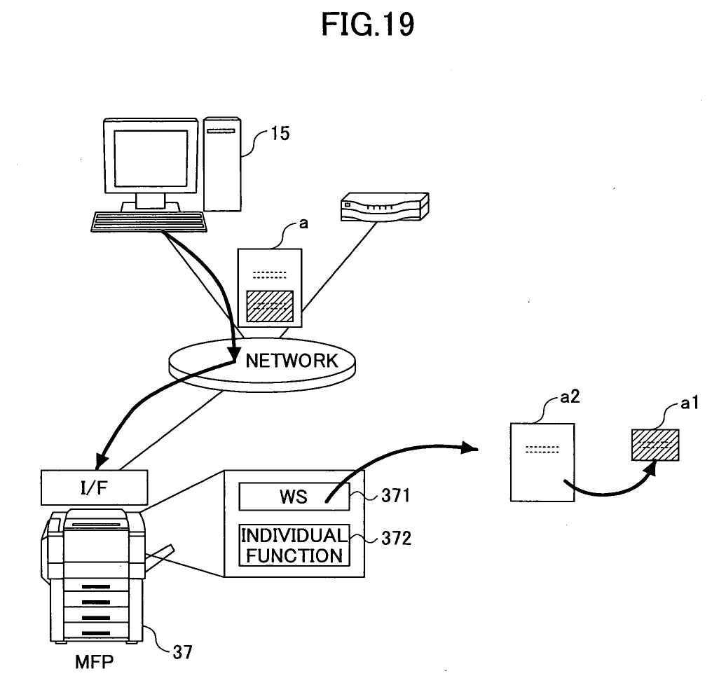

With reference to FIG. 19, a problem associated with the selection of request items in the WS portion is described. In FIG. 19, an image forming apparatus 37 includes a WS portion 371 and one or more function realizing units 372. The WS portion 371 acquires those of request items contained in a request that are registered in advance, and allocates them to the function realizing units 372.

However, when a function realizing unit 372 has been later added, a request item corresponding to the newly added function realizing unit may not be registered yet. In such a case, if the request item is overlooked by the WS portion 371, a problem arises in which the relevant function is not realized because of the failure to transmit the request item even though the function realizing unit 372 is implemented.

### (Transmission of Unknown Request Item)

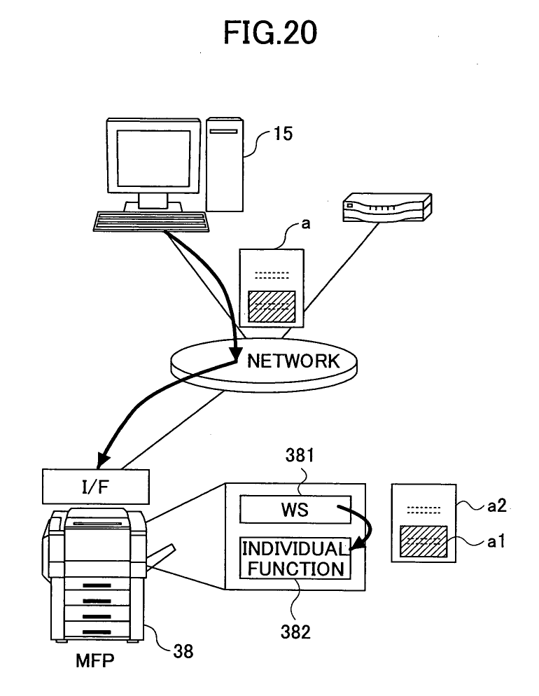

With reference to FIG. 20, allocation of a request item that is contained in a request but is not registered in advance is described. An image forming apparatus 38 includes a WS portion 381 and individual function realizing units 382. In the example shown, of a request a, both a portion a2 associated with a request item that is registered in advance, and a portion a1 associated with a request item that is not registered in advance, are allocated by the WS portion 381 to the individual function realizing units 382. In this way, process content corresponding to the request items can be processed by the function realizing units 382.

The request item that is not registered in advance may be a request item of which a corresponding data format cannot be acquired by the WS portion 381. Such a situation may arise when the function realizing unit 382 is associated with a function that is newly added to the image forming apparatus 38.

### (Transmission of Unknown Response Item)

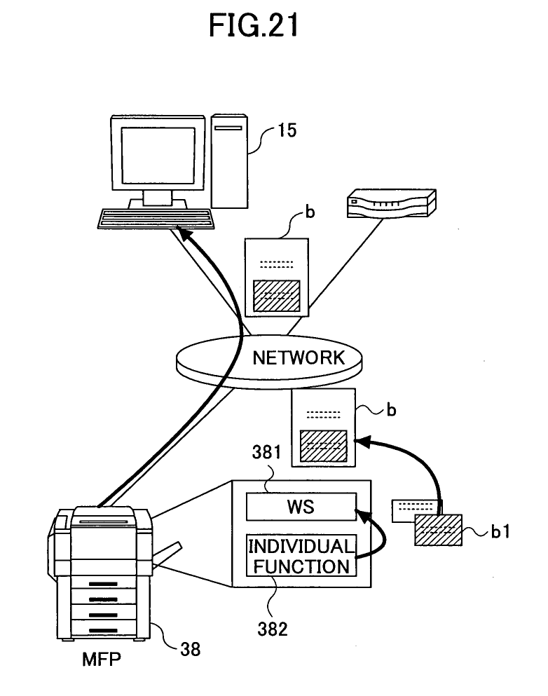

With reference to FIG. 21, an example of a process of generating a message including a response item that is not registered in advance is described. In FIG. 21, each function realizing unit 382 in an image forming apparatus 38 outputs a response item to a WS portion 381. Each of these response items may be in a predetermined data format corresponding to each function realizing unit 382. If the WS portion 381 cannot acquire a data format corresponding to a particular function realizing unit 382, the response item is acquired in a predetermined description format.

The function realizing unit 382 for which the WS portion 381 cannot acquire a data format for the response item may be a function realizing unit associated with a function that is newly added to the image forming apparatus 38. Or it may be a function realizing unit for which the data format of a request item cannot be acquired.

### (System Structure)

FIG. 7 shows an example of a structure of the image forming system. In this image forming system, PCs 1, 2, 3, . . . , and MFPs 4, 5, 6, . . . , are connected to a local area network (LAN). Each PC can output a request to any of the MFPs, and receive a response from any of the MFPs.

### (Structure of MFP)

FIG. 8 shows a structure of an MFP 300 as an image forming apparatus in the present embodiment. The MFP 300 includes an information processing logic unit 310, an information access unit 330, an information retaining unit 340, a communication server unit 351, a communication client unit 352, and a network interface (“I/F”) 390.

The information processing logic unit 310 analyzes a request from a client apparatus, and generates a response to the client apparatus. The information processing logic unit 310 may include a data processing unit 311. The data processing unit 311 parses a request described in XML, and generates a response described in XML.

The information access unit 330, based on a request item contained in the request analyzed by the information processing logic unit 310, acquires information retained in the information retaining unit 340, edits the information and replaces it, or generates information and saves it in the information retaining unit 340. The information retaining unit 340 may save the status of the image forming apparatus 300, identifying information about each operator, and image data.

The communication server unit 351 and the communication client unit 352 communicate with a client apparatus. The network I/F 390 provides an interface for connecting the image forming apparatus 300 with the LAN.

### (Functional Structure of the Image Forming System)

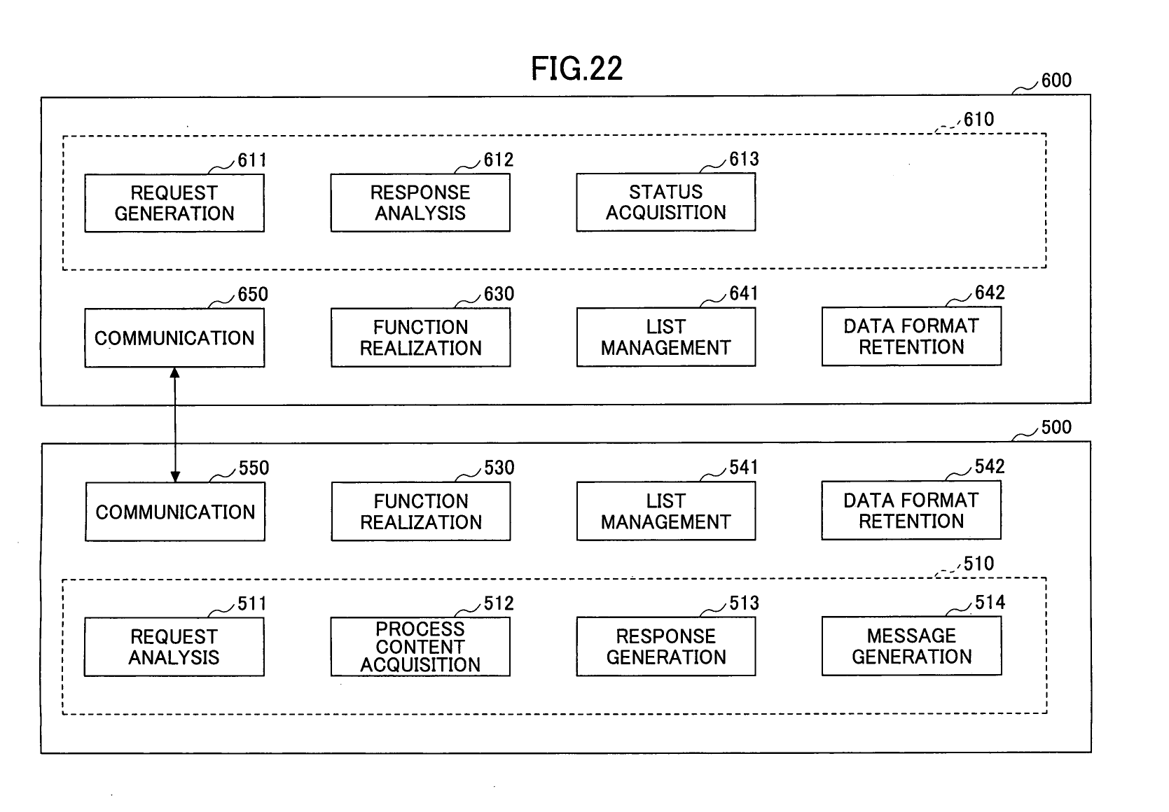

FIG. 22 shows a functional structure of the image forming system according to the present embodiment. In this example, an image forming apparatus 500 and a client PC 600 are connected, either directly or via a network.

The image forming apparatus 500 includes an information processing logic unit 510, a function realizing unit 530, a list managing unit 541, a data format retaining unit 542, and a communication unit 550. The information processing logic unit 510 analyzes a request transmitted from the client PC 600 and acquires a request item contained in the request. The information processing logic unit 510 also generates a response corresponding to the request item.

The information processing logic unit 510 includes a request analysis unit 511, a process content acquisition unit 512, a response generating unit 513, and a message generating unit 514. The request analysis unit 511 analyzes a request described in a first description format in accordance with its syntax. The first description format may be a description format that is expressed in XML and in which a group of items is identified by namespace. The request analysis unit 511 may be structured as an XML parser. Thus, request items contained in a request can be acquired.

The process content acquisition unit 512, based on the content analyzed by the request analysis unit 511, acquires identifying information of a function realizing unit and a process content corresponding to the request item. The process content acquisition unit 512 may convert the request item into a process content in a data format based on the data format for each function realizing unit retained in the data format retaining unit 542.

If the data format corresponding to the request item cannot be acquired, the process content acquisition unit 512 converts the request item into a predetermined description format. The predetermined description format may be a second description format consisting of a class having a namespace name, a variable or a tag name, and a value.

The data format may not be acquired when, for example, no data format as a data interface with the function realizing unit is registered in the data format retaining unit 542 because the function realizing unit corresponding to the request item has been newly added, although its identifying information is managed by the list managing unit 541.

Thus, even with regard to a function realizing unit of the image forming apparatus 500 that has been newly added, a request item can be outputted and a process can be instructed.

The response generating unit 513 generates a response corresponding to the request item processed by the function realizing unit 530. The response generated by the response generating unit 513 may be based on the version of the image forming apparatus 500. The response generated by the response generating unit 513 includes a response item outputted by the function realizing unit 530.

The response generating unit 513 converts the response item outputted from the function realizing unit 530 in a data format adapted to the function realizing unit, generating a response in the first description format. The response generating unit 513, when the response item outputted by the function realizing unit 530 is in the second description format, extracts necessary information from the response item and have the information contained in the response in the first description format.

The response item may be in the second description format when, for example, the function realizing unit is later added to the image forming apparatus 500 and, although its identifying information is registered in the list managing unit 541, no data format as a data interface with the function realizing unit is registered in the data format retaining unit 542.

Thus, a response corresponding to the response item outputted by the newly added function realizing unit of the image forming apparatus 500 can be generated.

The message generating unit 514, based on a predetermined event in the image forming apparatus 500, generates a message in which information about the status of the image forming apparatus 500 is described in a predetermined description format. The predetermined event may be the occurrence of an error in the image forming apparatus 500, such as the opening of a door or the absence of sheets. The message generated by the message generating unit 514 includes a status item outputted by the function realizing unit 530.

The message generating unit 514 converts the status item outputted by the function realizing unit 530, which is in a data format corresponding to the individual function realizing unit, generating a message in the first description format. The message generating unit 514, when the status item outputted by the function realizing unit 530 is in the second description format, also extracts necessary information from the status item, and puts the information in the message in the first description format.

The status item may be in the second description format in a case similar to the case where the response item is in the second description format. Thus, a message corresponding to the status item outputted by the newly added function realizing unit of the image forming apparatus 500 can be generated.

The function realizing unit 530, based on the request item acquired by the process content acquisition unit 512, carries out a corresponding process. The function realizing unit 530 may acquire information stored in a storage unit which is not shown and output it; edit information stored in the storage unit and replace it; or generate new information based on the request item and store it in the storage unit. The storage unit may additionally retain information about the status of the image forming apparatus 500, image data about images processed by the image forming apparatus 500, or information about an operator of the image forming apparatus 500.

The function realizing unit 530, in addition to the process relating to the information stored in the storage unit, may further perform processes concerning various functions of the image forming apparatus 500, such as an image formation function, a communication function, and a facsimile function. The function realizing unit 530 may be externally connected to the image forming apparatus 500.

The list managing unit 541 retains and manages a list of function realizing units of the image forming apparatus 500. When a new function realizing unit 530 is added, the list managed by the list managing unit 541 is updated.

The data format retaining unit 542 retains the data format for request items, response items, and/or status items for each function realizing unit. Thus, the process content acquisition unit 512, for example, can convert formats between the first description format and the data format corresponding to each function realizing unit.

The communication unit 550 communicates with the client PC 600 to receive a request or transmit a response or a message, for example.

The client PC 600 transmits a request to the image forming apparatus 500 and receives a response therefrom. Thus, the client PC 600 controls the image forming apparatus 500 and manages the information in the image forming apparatus 500.

The client PC 600 includes an information processing logic unit 610 and a communication unit 650. The information processing logic unit 610 generates a request transmitted to the image forming apparatus 500 and analyzes a response transmitted therefrom. Thus, the status of the image forming apparatus 500 can be acquired. The “status” may include information retained in the image forming apparatus 500, as well as the status of the image forming apparatus 500.

The information processing logic unit 610 includes a request generating unit 611, a response analysis unit 612, and a status acquisition unit 613. The request generating unit 611 generates a request including a request item requested from the image forming apparatus 500. The request generated by the request generating unit 611 may be expressed in the first description format.

The response analysis unit 612 analyzes a response or a message transmitted from the image forming apparatus 500. While the following description is made with reference to a response, the same applies to a message. The response analysis unit 612 may be structured as an XML parser when the response is described in XML.

The status acquisition unit 613, based on the response item or status item analyzed by the response analysis unit 612, acquires the status of the image forming apparatus 500. The status acquisition unit 613 also, based on the acquired status, allocates a response item to the function realizing unit 630. Thus, the individual function realizing unit 630 can perform a process corresponding to a particular response item.

The status acquisition unit 613 converts the response item into a data format corresponding to each function realizing unit. The status acquisition unit 613, when the data format corresponding to the response item is not retained in the data format retaining unit 642, converts the response item into the second description format and outputs it.

The response item may be in the second description format in a case similar to the case of the image forming apparatus 500, where the response item corresponds to a function realizing unit 630 that is newly added to the client apparatus 600. Thus, a response item or a status item can be outputted even for a newly added function realizing unit of the client apparatus, and a corresponding process can be performed.

The functions and structures of the function realizing unit 630, the list managing unit 641, the data format retaining unit 642, and the communication unit 650 are the same as those of the units of the image forming apparatus 500 with the same designations; thus, their descriptions are omitted.

### Example 1 of Process Based on Request from Client

FIG. 10 shows a sequence chart for a process based on a request from a client that is performed in the image forming apparatus 300. In step S101, a PC 100 transmits a request to the communication server unit 351. The request may include request items for setting a condition, or referring, modifying, or deleting information. The request may be transmitted as an HTTP request. The request may be described in the first description format using a description language such as XML.

In step S102, the communication server unit 351 outputs a request to the information processing logic unit 310 to process the request received in step S101. The received request to be processed may be a request to manipulate data in an address book retained in the information retaining unit 340 of the image forming apparatus 500.

In step S103, the information processing logic unit 310 outputs a request to the data processing unit 311 to analyze the request data.

In step S104, the data processing unit 311 analyzes the request and acquires a request item contained in the request. The request may be described in accordance with the Atom Publishing Protocol (“APP”), Atom, or other extended description format. Thus, the data processing unit 311 acquires the request item and the identifying information of the relevant function realizing unit, in accordance with the particular description format. The identifying information that is acquired may be that of the information access unit 330.

The data processing unit 311, based on the acquired function realizing unit, converts the request item into a data format corresponding to the function realizing unit, thereby creating a process content. When there is no data format corresponding to the function realizing unit, the request item is converted into a predetermined second description format.

The second description format may include, when the request is described in XML, a namespace name to which the request item belongs, a variable name or a tag name, and a value.

In step S105, the data processing unit 311 outputs the acquired process content or the request item converted into the second description format, and a notice of completion of analysis of the request, to the information processing logic unit 310. The information processing logic unit 310 thus acquires the process content corresponding to each request item, or the request item converted into the second description format.

In step S106, the information processing logic unit 310 outputs a request to execute the process content to the information access unit 330. In step S107, the information access unit 330 accesses the information retaining unit 340, whereby a process based on the request received in step S101 is performed.

In step S108, the information processing unit 340 outputs a notice of end of process to the information access unit 330. In step S109, the information access unit 330 outputs a notice of end of process to the information processing logic unit 310. In step S110, the information processing logic unit 310 outputs a request to notify the PC 100 of the end of process to the communication server unit 351. In step S111, the communication server unit 351 transmits to the PC 100 a notice of the end of process in the form of an HTTP response, for example.

### Example 2 of Process Based on a Request from Client

FIG. 11 shows a sequence chart for a process based on a request from a client that is performed in the image forming apparatus 300. In this example, the image forming apparatus 300 transmits a response to the PC 100. Steps S201 through S208 are identical to steps S101 through S108 of FIG. 10, and therefore their description is omitted herein.

In step S209, the information access unit 330 outputs a response item indicating the end of process to the information processing logic unit 310. The response item may be in a predetermined data format corresponding to the information processing logic unit 310, or in the second description format. The second description format may include, when the response is described in XML, a namespace name to which the response item belongs, a variable name or a tag name, and a value.

In step S210, the information processing logic unit 310 outputs a request to the data processing unit 311 to generate a response. In step S211, the data processing unit 311 generates a response including a response item corresponding to each process content processed in step S204, for example. The response is described in a first description format, and may be described in XML. More particularly, it may be described in APP, Atom, or other extended format. Which format is used for description depends on, for example, the described content of the request indicating a desired format for response, or the formats supported by the image forming apparatus.

In step S212, the data processing unit 311 outputs a notice of the end of generation of response and the response to the information processing logic unit 310. The output of the response may double as the notice of the end of generation of response.

In step S213, the information processing logic unit 310 outputs to the communication server unit 351 the response and a request to transmit the response. In step S214, the communication server unit 351 transmits the response to the PC 100.

### (Process of Generating and Transmitting a Message)

FIG. 12 shows a sequence chart for a process in which the image forming apparatus 500 transmits a message based on a predetermined event to the PC 100. In step S301, a triggering module notifies the information processing logic unit 310 of the occurrence of an event. The event may be the occurrence of abnormality, such as the opening of a door in the image forming apparatus 500.

In step S302, the information processing logic unit 310 outputs a data acquiring request to the information access unit 330. This is because the content in the notice in step S301 is information indicating the occurrence of an event of which the details can be obtained by referring to the information retained in the information retaining unit 340.

In step S303, the information access unit 330 outputs a data acquisition request to the information retaining unit 340. In step S304, the information retaining unit 340 outputs data to the information access unit 330. The data includes detailed information about the event. In step S305, the information access unit 330 outputs the data acquired in step S304 to the information processing logic unit 310.

The data outputted by the information access unit 330 may be in a data format corresponding to the information access unit 330, or in the second description format.

In step S306, the information processing logic unit 310 outputs a message generation request to the data processing unit 311. In step S307, the data processing unit 311 generates a message based on the detailed information about the event contained in the data. The message is expressed in a predetermined description format. In step S308, the data processing unit 311 outputs a notice that the preparation of the message is complete and the message to the information processing logic unit 310. The output of the message may double as the notice of completion of the preparation of the message.

In step S309, the information processing logic unit 310 outputs a message transmission request to the communication client unit 352. In step S310, the communication client unit 352 outputs the message to the PC 100. The message may be transmitted as an HTTP request.

In step S311, the PC 100 transmits a notice of reception of the message to the communication client unit 352 in the form of an HTTP response, for example. In step S312, the communication client unit 352 outputs a notice of reception of the message to the information processing logic unit 310.

### (Analysis of a Request)

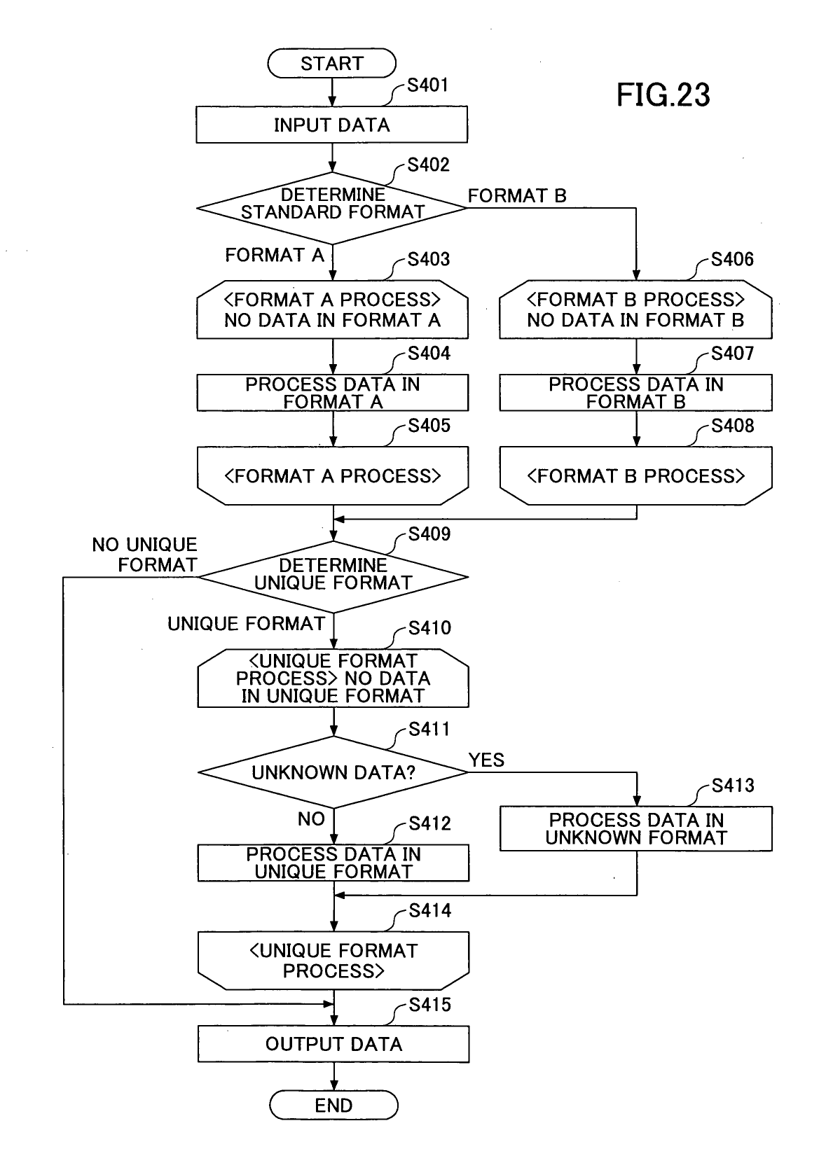

FIG. 23 shows a flowchart of a process in which a request is analyzed in the information processing logic unit 310 and the data processing unit 311. The process of FIG. 23 may be carried out by the request analysis unit 511 in step S104 of FIG. 10 or in step S204 of FIG. 11. In step S401 of FIG. 23, a request is entered into the data processing unit 311.

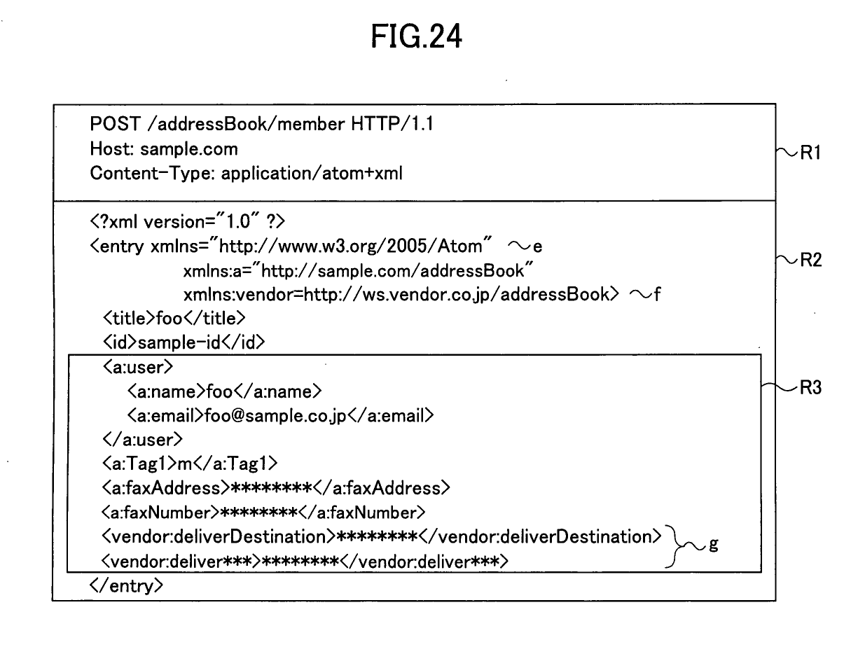

FIG. 24 shows an example of a request to add new record to an address book retained in a storage unit or the like (not shown) of the image forming apparatus 500. The storage unit may have the same structure as that of the data format retaining unit 542.

The request of FIG. 24 includes an HTTP request header portion R1 and a main body R2 that includes request items. In the main body R2, a portion of code e indicates that the request is described in Atom and an extended format defined by a namespace “a” and a namespace “vendor.” The extended format defined by the namespace “vendor” corresponds to the request item concerning a newly added function in the present embodiment.

R3 is a portion described in the extended format. R3 includes a mail address corresponding to the name “foo” and information about records such as a facsimile number as individual request items. R3 further includes a value g having a tag identified by the namespace “vendor.”

Referring back to FIG. 23, in step S402, the request analysis unit 511 analyzes the request from its head to determine the standard format portion. Specifically, it is determined whether the standard format is format A or format B. If it is format A, the routine proceeds to step S403; if it is format B, it proceeds to step S406.

The standard format may be a general standard such as APP or Atom when the request is described in XML. While one of two standard formats is processed in the present embodiment, one or more standard formats out of three or more standard formats may be processed in another embodiment.

In steps S403 to S405, with regard to the portion described in format A, the request analysis unit 511 acquires a request item. Further, the process content acquisition unit 512 acquires a process content corresponding to the request item. The acquired process content has a data format corresponding to an individual function realizing unit. This process is repeated until all of the portions described in format A are processed.

The identifying information about each function realizing unit is acquired by the request analysis unit 511. The identifying information about each function realizing unit may be included in each request item in the request, or it may be associated with each description format in the request.

In steps S406 to S408, with regard to portions described in format B, the request analysis unit 511 and the process content acquisition unit 512 perform processes similar to those in steps S403 to S405.

After the portions described in the standard format are processed, the unique format is processed. In step S409, the request analysis unit 511 determines the presence or absence of a unique format in the request. If there is a unique format, the routine proceeds to step S410; if there is not, it proceeds to step S414. The determination in step S409 may be made based on the presence or absence of an item group of request items corresponding to the function of the image forming apparatus 500, instead of the presence or absence of the unique format. If there is an item group of request items corresponding to the function of the image forming apparatus 500, the routine proceeds to step S410; if there is not, it proceeds to step S415.

In steps S410 to S414, the request analysis unit 511 repeats the process of acquiring the request items contained in the request until all of the request items are acquired. Each time a request item is acquired, the process content acquisition unit 512 determines the presence or absence of registration of a process content corresponding to the request item in step S411. If there is a registered process content, the routine proceeds to step S412; if there is not, it proceeds to step S413.

In step S412, the process content acquisition unit 512 acquires the process content in a data format corresponding to each function realizing unit. On the other hand, in step S413, the process content acquisition unit 512 converts the request item into the second description format.

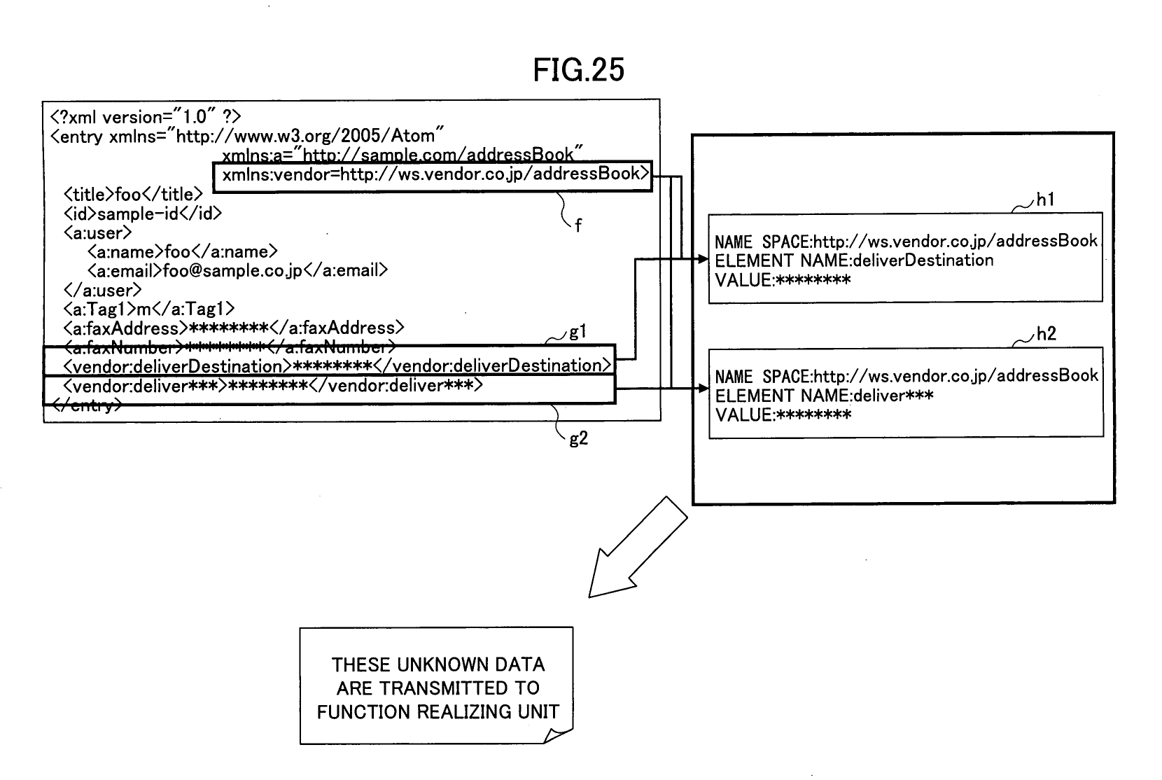

With reference to FIG. 25, the conversion of the request item into the second description format is described. In FIG. 25, a request item h1 is formed from a namespace designated with a code f and an element designated with a code g1. From a namespace designated with a code f and an element designated with a code g2, a request item h2 is formed.

Thus, even when the request includes a request item corresponding to a function that is not registered in the image forming apparatus 500, the function can be performed. For example, when the image forming apparatus 500 has a newly added function realizing unit, a client apparatus or the like that generates a request can output a request for the new function.

Referring back to FIG. 23, after the process in step S409 or step S413, the acquired process content is outputted to the information processing logic unit 310 in step S414.

### (Process of Generating a Response or a Message)

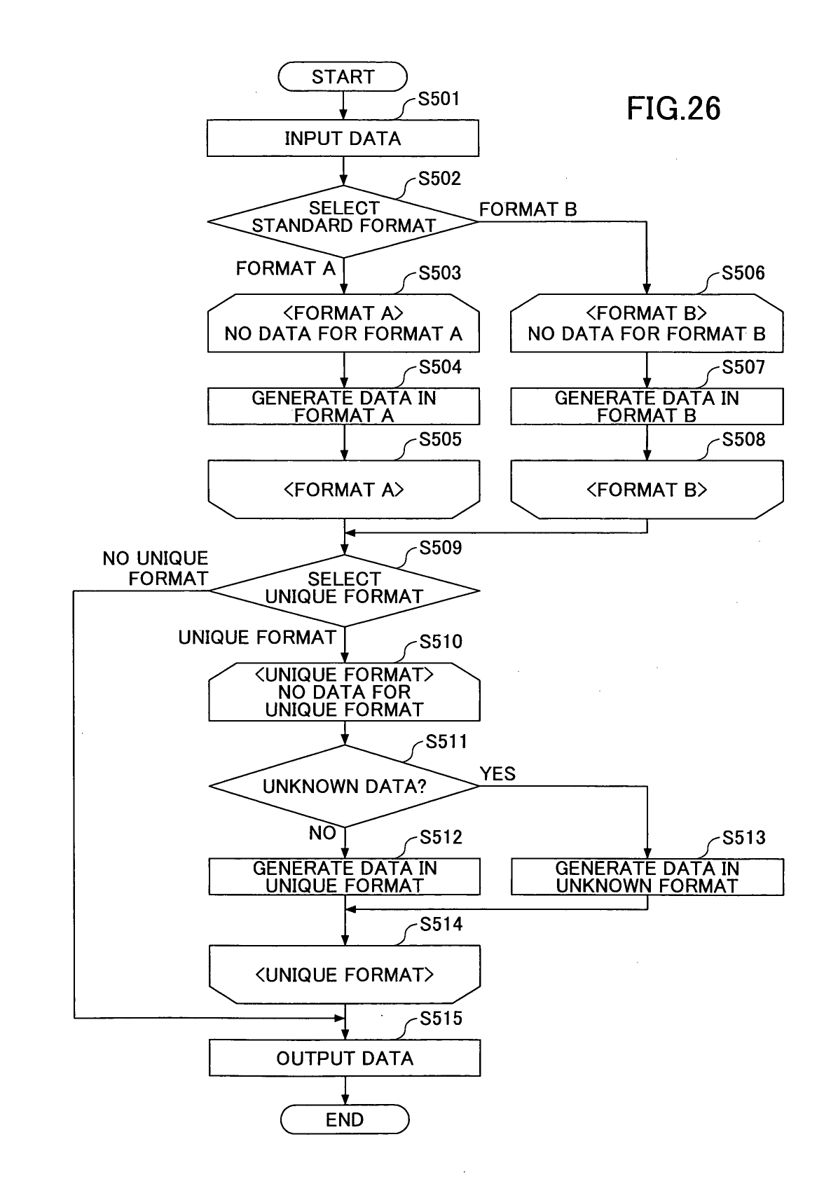

FIG. 26 shows a flowchart of an example of a process of generating a response or a message in the information processing logic unit 310 and the data processing unit 311. The process of FIG. 26 may be performed by the response generating unit 513 in step S211 of FIG. 11, or by the message generating unit 514 in step S307 of FIG. 12. In the example shown, the process is performed by the response generating unit 513.

In step S501, data about response items contained in a response is entered from the information processing logic unit 310 into the data processing unit 311. In step S502, the response generating unit 513, based on the thus entered data, selects a description format of the response. Specifically, a standard format portion is selected, and, when describing in format A, the routine proceeds to step S503; when describing in format B, the routine proceeds to step S506.

While one of two standard formats is selected in the present embodiment, one or more standard formats may be selected out of multiple standard formats in order to generate a response described in the selected standard formats.

In steps S503 to S505, the response generating unit generates the data for the response items that are described in format A until there is no more data for the response items described in format A. On the other hand, in steps S506 to step S508, the response generating unit similarly generates the data for the response items that are described in format B until there is no more data for the response items described in format B.

In step S509 following step S505 or S508, the response generating unit 513 determines the presence or absence of response item data that is described in the unique format. If there is data described in the unique format, the routine proceeds to step S510; if there is not, the routine proceeds to step S515.

In steps S510 to S513, the response generating unit 513 repeats the process of describing the response items in the unique format until there is no more response item data described in the unique format. In step S511, the response generating unit 513 determines whether a response item is unknown data. The unknown data may be data for a response item that does not have a pre-registered data format. The unknown data may be described in the second description format. The second description format may include a namespace name, a variable name or a tag name, and a value.

In the case of known data, the routine proceeds to step S512; in the case of unknown data, it proceeds to step S513. In step S512, the response generating unit 513 generates a response in the first description format by referring to the data format of the acquired response item. On the other hand, in step S513, the response generating unit 513 generates a response in the first description format based on the acquired response item in the second description format.

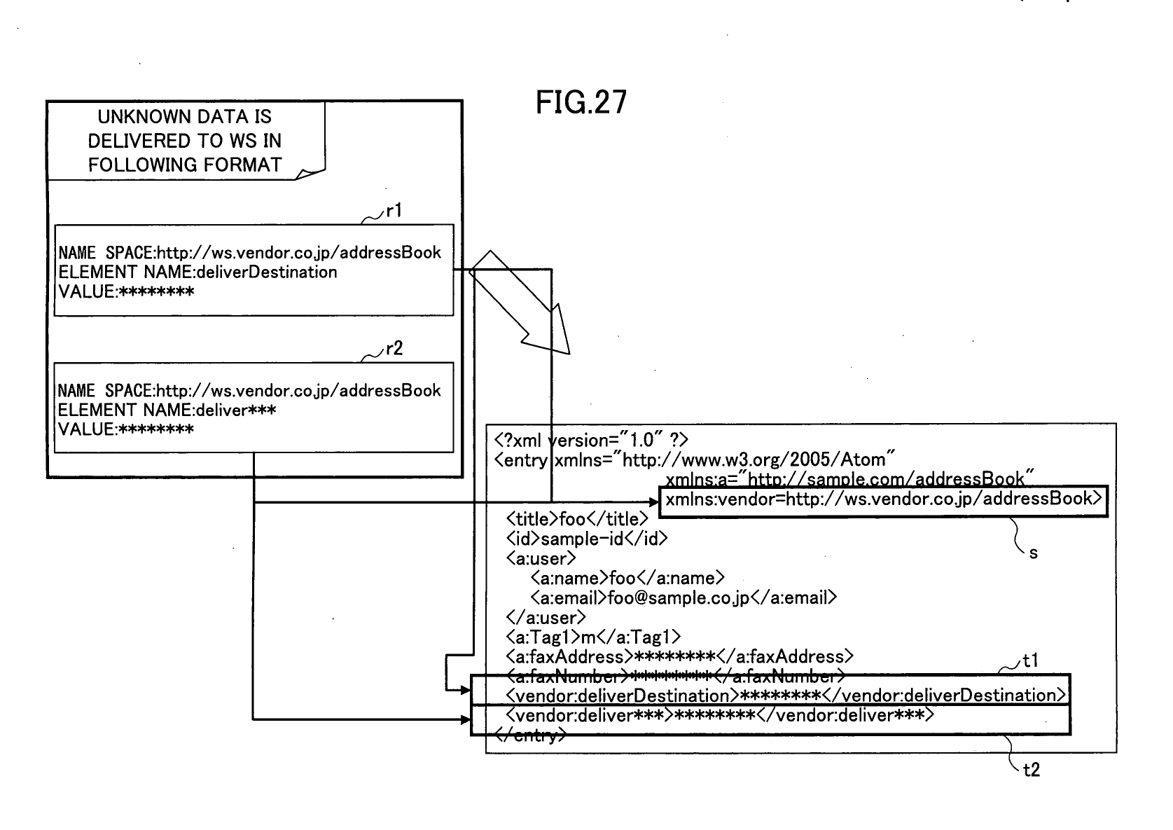

With reference to FIG. 27, the process of generating the response in the first description format based on the response item in the second description format is described. In FIG. 27, a namespace s and an element t1 are generated from a response item designated with a code r1, and a namespace s and an element t2 are generated from a response item designated with a code r2.

Referring back to FIG. 26, following step S509 or step S512 and S513, the response generated by the response generating unit 513 is outputted to the information processing logic unit 310.

### (Response)

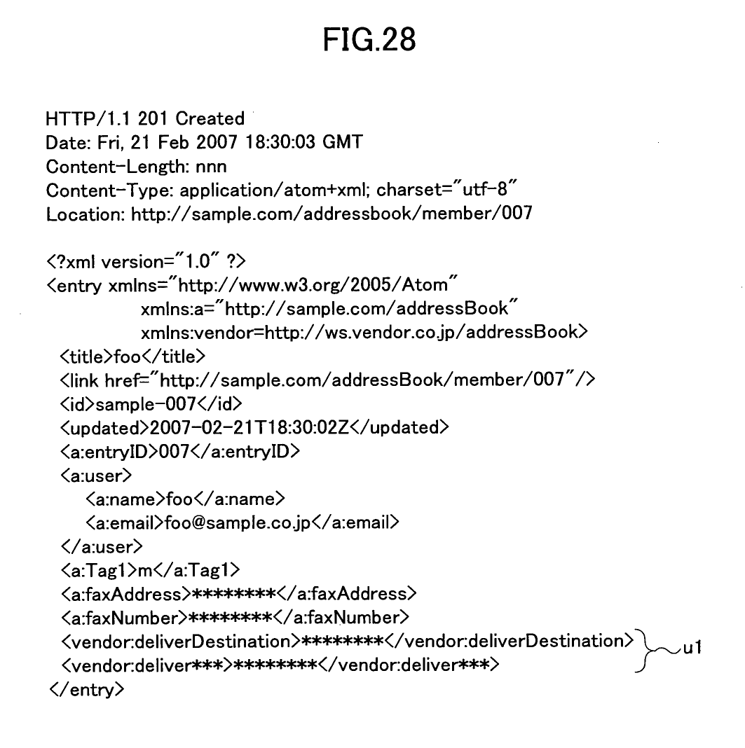

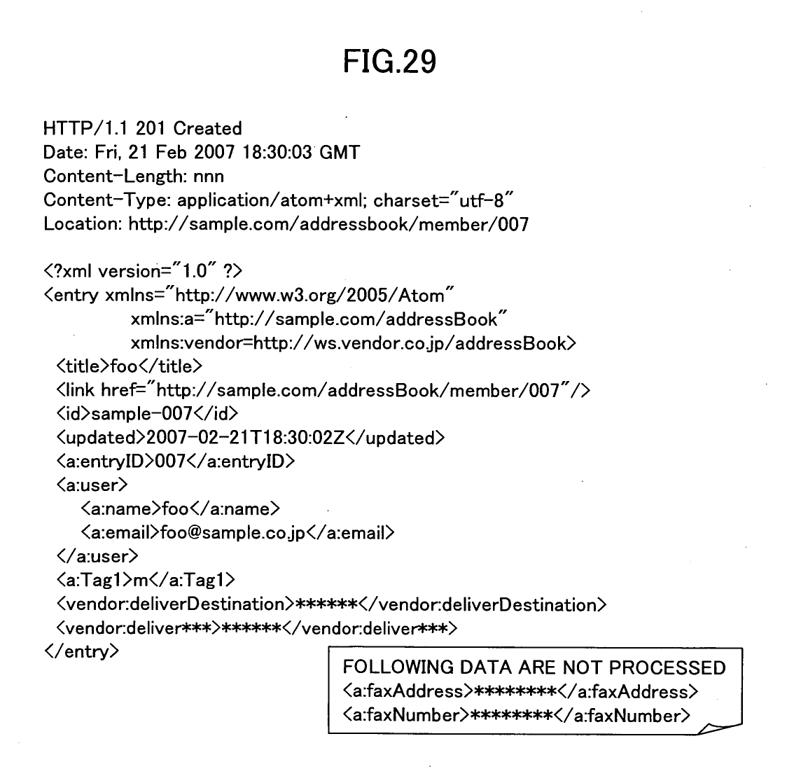

With reference to FIGS. 28 and 29, an example of a response is described. FIG. 28 shows an example of a response generated in response to the request of FIG. 25. The example of FIG. 28 includes content that has been processed based on the request of FIG. 25. Namely, the content of records added to the address book, such as the name “foo” and corresponding mail address, a facsimile number, etc. are included, each as an individual response item. Further, at the portion designated with a code u1, there is included a response item identified by a namespace “vendor” for an operation on the address book.

FIG. 29 shows another example of a response generated in response to the request of FIG. 24. The response shown in FIG. 29 does not include the response items corresponding to “faxAddress” and “faxNumber.” This is because the image forming apparatus that generated this response does not have the function to have such information included in the address book.

When editing data in the address book, HTTP PUT may be used to enter a request and output a response. When referring to data in the address book, HTTP GET may be used to output response data. When deleting data in the address book, HTTP DELETE may be used without there being an exchange of request and response data.

### (Message)

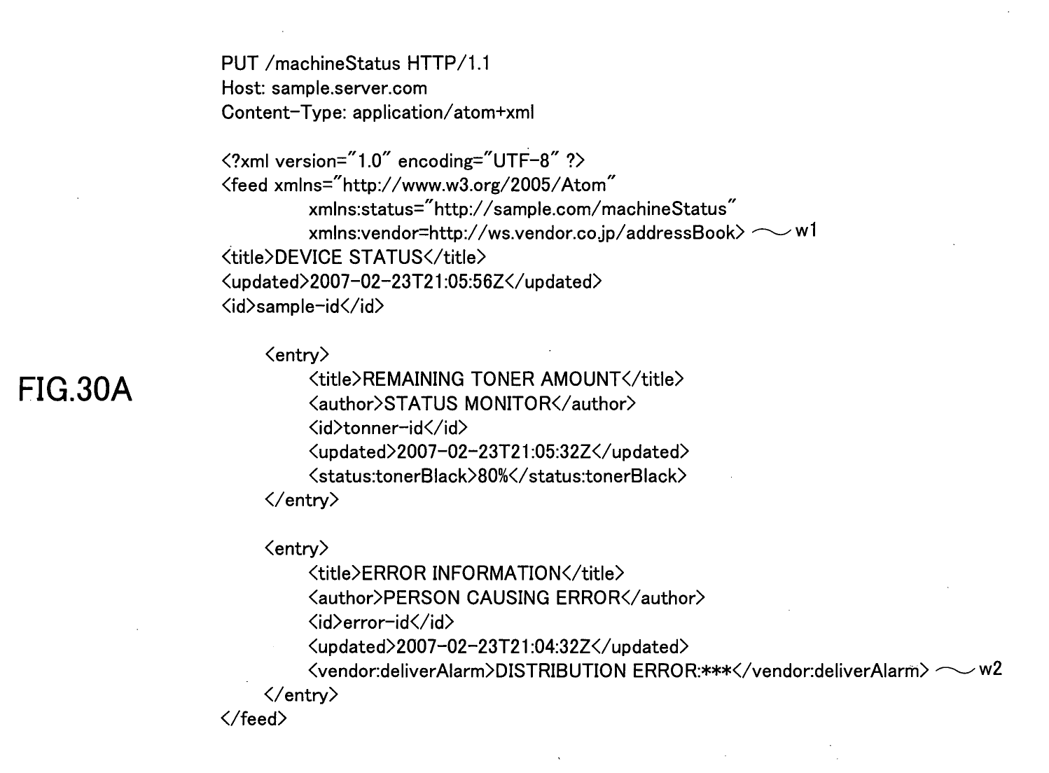

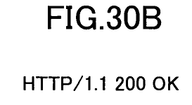

FIG. 30A shows an example of a message notifying the client PC of an occurrence of abnormality in the image forming apparatus. FIG. 30B shows an example of a response to the message that is outputted by the client PC.

In FIG. 30A, a namespace with a code w1 and an element with a code w2 are response items obtained by conversion from the second description format. In the present example, the message is transmitted as a HTTP request, while the response is returned as an HTTP response.

Although this invention has been described in detail with reference to certain embodiments, variations and modifications exist within the scope and spirit of the invention as described and defined in the following claims.

The present application is based on the Japanese Priority Applications No. 2007-224098 filed Aug. 30, 2007, and No. 2007-290216 filed Nov. 7, 2007, the entire contents of which are hereby incorporated by reference.

What is claimed is:

1. An image forming apparatus comprising:
a communication unit configured to receive a request from a client apparatus in a predetermined description format;
a request analysis unit configured to analyze the request to acquire and output a request item included in the request;
a process content acquisition unit configured to acquire a process content corresponding to the request item outputted from the request analysis unit, and configured to receive a next output from the request analysis unit in the absence of the process content corresponding to the request item; and
an executing unit configured to execute a process corresponding to the request item.

2. The image forming apparatus according to claim 1, wherein each request item belongs to any one of a plurality of item groups, and the request includes a request item of one or more of the item groups.

3. The image forming apparatus according to claim 2, wherein the process content acquisition unit determines the presence or absence of the process content corresponding to the request item based on the item group to which the request item belongs.

4. The image forming apparatus according to claim 1, including a response generation unit configured to generate a response in which a response item corresponding to the process content executed by the executing unit is described in a predetermined description format,
wherein the communication unit transmits the response to the client apparatus.

5. The image forming apparatus according to claim 4, wherein the response item belongs to the item group to which a request item corresponding to the process content associated with the response item belongs.

6. The image forming apparatus according to claim 1, further comprising a message generation unit configured to generate a message in which a status item corresponding to information about an event in the image forming apparatus is described in a predetermined description format,
wherein the communication unit transmits the message to the client apparatus.

7. The image forming apparatus according to claim 2, wherein the predetermined description format is expressed in XML, and wherein the item groups are identified by namespace.

8. An image forming apparatus comprising:
a list managing unit configured to manage a list of one or more function realizing units connected to the image forming apparatus;
a communication unit configured to receive a request from a client apparatus in a first description format;
a request analysis unit configured to analyze the request to acquire and output identifying information about the function realizing unit and a request item included in the request;
a data format retaining unit configured to retain a data format for a process content corresponding to the request item for each of the function realizing units; and
a process content acquisition unit configured to output, based on an output from the request analysis unit, the request item to the function realizing unit in the data format of the process content, and configured to output, in the absence of the process content corresponding to the function realizing unit, the request item to the function realizing unit in a second description format.

9. The image forming apparatus according to claim 8, wherein each request item belongs to one of a plurality of item groups, and the request includes a request item of one or more of the item groups.

10. The image forming apparatus according to claim 9, wherein the process content acquisition unit determines the presence or absence of a process content corresponding to the request item based on the item group to which the request item belongs.

11. The image forming apparatus according to claim 8, wherein the data format retaining unit further retains a data format for a response item corresponding to the process content for each of the function realizing units,
the apparatus further comprising a response generating unit configured to acquire a response item in a data format of the response item and/or a response item in the second description format from the function realizing unit, and configured to generate a response in which the response item is described in the first description format,
wherein the communication unit transmits the response to the client apparatus.

12. The image forming apparatus according to claim 11, wherein the response item belongs to an item group to which the request item of a process content corresponding to the response item belongs.

13. The image forming apparatus according to claim 8, wherein the data format retaining unit further retains a data format for a status item concerning a status of each of the function realizing units,
the apparatus further comprising a message generating unit configured to acquire the status item in the data format for the status item and/or the status item in the second description format from the function realizing unit, and configured to generate a message in which the status item is described in the first description format,
wherein the communication unit transmits the message to the client apparatus.

14. The image forming apparatus according to claim 9, wherein the first description format is expressed in XML, and the item groups are identified by namespace.

15. An image forming system in which a client apparatus and an image forming apparatus are connected,
wherein the client apparatus comprises:
a request generating unit configured to generate a request having a request item for the image forming apparatus in a first description format; and
a communication unit configured to transmit the request,
wherein the image forming apparatus comprises:
a list managing unit configured to manage a list of one or more function realizing units connected to the image forming apparatus;
a communication unit configured to receive a request from the client apparatus in the first description format;
a request analysis unit configured to analyze the request to acquire and output identifying information about the function realizing unit and a request item included in the request;
a data format retaining unit configured to retain a data format for a process content corresponding to the request item for each of the second function realizing units; and
a process content acquisition unit configured to output the request item, based on the output from the request analysis unit, to the function realizing unit in a data format for the process content, and configured to, in the absence of the process content corresponding to the function realizing unit, the request item to the function realizing unit in a second description format.

16. The image forming system according to claim 15, wherein, in the image forming apparatus, the data format retaining unit further retains a data format for a response item corresponding to the process content for each of the function realizing units,
the image forming apparatus further comprising:
a response generating unit configured to acquire a response item in the data format of the response item and/or a response item in the second description format from the function realizing unit, and configured to generate a response in which the response item is described in the first description format,
wherein the second communication unit transmits the response to the client apparatus.

17. The image forming system according to claim 16, wherein the client apparatus receives the response using the communication unit of the client apparatus,
the client apparatus further comprising:
a list managing unit configured to manage a list of one or more function realizing units connected to the client apparatus;
a response analysis unit configured to analyze the response to acquire and output identifying information about the function realizing unit and a response item included in the response;
a data format retaining unit configured to retain a data format for a process content corresponding to the response item for each of the function realizing units; and
a process content acquisition unit configured to output the response item, based on the output of the response analysis unit, to the function realizing unit connected to the client apparatus in a predetermined data format, and configured to, in the absence of the data format corresponding to the function realizing unit of the client apparatus, output the response item to the function realizing unit of the client apparatus in a second description format.

18. The image forming system according to claim 17, wherein each response item belongs to one of a plurality of item groups,
wherein the response includes a response item of one or more of the item groups,
wherein the status acquisition unit acquires, based on the item group to which the response item belongs, a status of the image forming apparatus corresponding to the response item.

19. The image forming system according to claim 16, wherein the transmission of the request by the communication unit of the client apparatus and the transmission of the response by the communication unit of the image forming apparatus are carried out in accordance with a predetermined protocol.

20. The image forming system according to claim 15, wherein the communication unit of the image forming apparatus communicates with the client apparatus via a predetermined interface.
